(19) United States
(12) Patent Application Publication
(10) Pub. No.: US 2016/0248061 A1
(43) Pub. Date: Aug. 25, 2016

(54) BATTERY MODULE HAVING SAFETY SECTION, BATTERY PACK AND ELECTRICAL VEHICLE

(71) Applicant: COVESTRO DEUTSCHLAND AG, Leverkusen (DE)

(72) Inventors: ROLAND BRAMBRINK, Leichlingen (DE); Ulrich GROSSER, Kürten (DE)

(21) Appl. No.: 15/026,317

(22) PCT Filed: Sep. 29, 2014
(86) PCT No.: PCT/EP2014/070734

§ 371 Date: Mar. 31, 2016

(30) Foreign Application Priority Data
Oct. 2, 2013 (EP) 13187016.4

(51) Int. Cl. H01M 2/12; C08L 69/00; B60L 11/18; H01M 2/10; B60K 1/04

(52) U.S. Cl. CPC H01M 2/1235; H01M 2/1282; H01M 2/1094; B60K 1/04; B60L 11/1879; C08L 69/00; H01M 2220/20; H01M 2200/00; B60K 2001/0416

(57) ABSTRACT

The invention relates to a battery module (8) having a battery module housing (10), wherein the battery module housing (10) encloses a battery module interior (12), wherein the battery module housing (10) has, on the battery module interior side, accommodation spaces (14) for a given number of battery cells (16), and wherein the battery module housing (10) comprises, in the region of at least one accommodation space (14), a safety wall section (20) having such material properties and such a thickness that the safety wall section (20), in the needle flame test to DIN EN ISO 11925-2, burns through after not more than 45 s, preferably not more than 20 s, further preferably not more than 10 s, especially not more than 5 s. The invention further relates to a battery pack (2) having a battery pack housing (4), wherein the battery pack housing (4) encloses a battery pack interior (6), wherein the battery pack housing (4) has, on the battery pack interior side, at least one accommodation space for a battery module (8), and wherein the battery pack (2) has an inventive battery module (8) accommodated in the accommodation space. The invention finally also relates to an electrical vehicle (42), wherein the electrical vehicle (42) has an inventive battery module (8) and/or an inventive battery pack (2).

The invention relates to a battery module having a battery module housing, wherein the battery module housing encloses a battery module interior, and wherein the battery module housing has, on the battery module interior side, accommodation spaces for a given number of battery cells. The invention further relates to a battery pack having a battery pack housing, wherein the battery pack housing encloses a battery pack interior, and wherein the battery pack housing has, on the battery pack interior side, at least one accommodation space for a battery module. Finally, the invention also relates to an electrical vehicle.

Battery modules and battery packs of the aforementioned type are increasingly being used as electrical storage means in electrical vehicles. Electrical vehicles have an electric motor which drives the motor vehicle either alone or—in the case of hybrid electric vehicles—in combination with a fuel-driven motor, and also a number of battery cells in order to store the energy required for operation of the electric motor. In order to be able to achieve a maximum range before the battery cells have to be recharged, a large number of battery cells having a high total capacity is typically integrated into the vehicle. Battery cells in the present context are especially understood to mean chargeable battery cells, i.e. accumulators.

A given number of battery cells is typically combined to form a battery module, in which the battery cells are surrounded by a battery module housing. A plurality of such battery modules are also typically combined to form a battery pack, which is then installed into an electrical vehicle.

The need for high loading space and high possible payload with simultaneously low consumption is manifested in the case of electrical vehicles in the drive to minimize the size and weight of the battery cells or battery modules, or battery packs. For this reason, preference is given to using battery cells having a high energy storage density, such as lithium ion accumulators in particular.

Because of their high energy density, however, these battery cells also result in an endangerment potential for the vehicle. In the event of damage to and/or short-circuiting of a battery cell, for example as a result of a crash, a hot flame may escape from the battery cell. Such a flame can cause vehicle fires and even vehicle explosions. More particularly, the close packing of the battery cells within a battery module can result in the flame from one battery cell likewise damaging other battery cells, such that this can effectively result in a chain reaction, with fatal consequences for the vehicle and possibly for its occupants.

In order to prevent uncontrolled escape of a flame from damaged battery cells, battery cells known from the prior art have preferential fracture sites, such that, in the event of a short circuit, a flame does not escape from the battery cell in arbitrary directions, but in a direction defined by the preferential fracture site. Typically, such a preferential fracture site is in the base region of the particular battery cell, such that a flame escapes from the battery cell in a controlled downward direction. This can, for example, reduce the risk that adjacent cells are likewise damaged and especially ignited by a laterally escaping jet of flame.

In order to further reduce the endangerment potential emanating from the battery cells, the battery module housing around the battery cells and the battery pack housing around the battery module housing, in the prior art, are typically made to be sufficiently rigid and robust that the battery cells remain essentially undamaged in the event of a crash. For this purpose, battery module housing and battery pack housing are typically manufactured from a thick metal sheet, especially steel sheet, in order to protect the battery cells from a possible crash, effectively in a kind of safe.

These steel housings, however, have the disadvantage that they are heavy and costly, and hence lower the economic viability of the electrical vehicle. Moreover, some steel housings, especially steel housings with a thinner design for weight optimization, have been found to be inadequate for giving the battery cells sufficient protection in the event of a crash.

Steel housings have the additional disadvantage that, in the event of damage to a battery cell within the housing, the flame that escapes from the battery cell can significantly heat the battery module interior. As a result, further battery cells can be damaged, so as to result in the dreaded chain reaction of the battery cells.

Proceeding from this prior art, it was an object of the present invention to improve the operational safety of a battery module, for example of a battery module for an electrical vehicle, and at the same time to reduce or to avoid disadvantages of heavy and costly steel housings.

This object is achieved in accordance with the invention, in a battery module having a battery module housing, wherein the battery module housing encloses a battery module interior, and wherein the battery module housing has, on the battery module interior side, accommodation spaces for a given number of battery cells, at least partly by virtue of the battery module housing comprising, in the region of at least one accommodation space, a safety wall section having such material properties and such a thickness that the safety wall section, in the needle flame test to DIN EN ISO 11925-2, burns through after not more than 45 s, preferably not more than 20 s, further preferably not more than 10 s, especially not more than 5 s.

The burning-through of the safety wall section after not more than 45 s, preferably not more than 20 s, further preferably not more than 10 s, especially not more than 5 s, in the needle flame test, i.e. after a maximum flaming time with a defined flame, forms a hole in the safety wall section and hence in the battery module housing.

The provision of such a safety wall section in the region of at least one accommodation space therefore achieves the effect that the battery module housing, in the case of a battery cell malfunction, burns through rapidly as a result of a flame that escapes from the battery cell, such that the energy released by the flame can escape from the battery module through the hole thus formed in the battery module housing.

The flame that escapes from a faulty battery cell, especially from a lithium ion battery cell, typically has a higher temperature than the flame in the needle flame test to DIN EN ISO 11925-2, for example a temperature of 600° C. or higher. It has been found that a safety wall section which burns through in the needle flame test after not more than 45 s, preferably not more than 20 s, further preferably not more than 10 s, especially not more than 5 s, achieves burn-through times of a few seconds on contact with a typical flame that escapes from a battery cell, especially of not more than 4 s, especially not more than 3 s, such that a hole forms in the safety wall section within a few seconds and hence in the battery module housing after the flame has appeared, such that the energy from the flame can escape from the battery module housing.

In the form of the safety wall section, the battery module thus effectively has a preferential fracture site at which the action of the flame has formed a hole after no more than a few seconds, from which the flame can escape from the battery module. The controlled diversion of the flame can especially reduce the risk of the flame jumping over to adjacent battery cells, or of damage to the adjacent battery cells as a result of excessive heating of the battery module interior, and hence of a chain reaction of malfunctions of the other battery cells.

In the context of the present invention, it has especially been found that the flame can reliably be prevented from jumping over, or excessive heating of the battery module interior can be reliably prevented, when the safety wall section has the aforementioned maximum burn-through time in the needle flame test, such that the battery module housing has a hole in the region of the damaged battery cell no more than a few seconds after the appearance of the flame. Compared to a permanent hole in the battery module housing, the provision of a safety wall section additionally has the advantage that the battery cells in normal operation, i.e. in the proper working of the battery cells, are still reliably protected from outside influences, and cooling of the battery cells in a closed housing is enabled.

Preferably, corresponding safety wall sections may be provided in the region of several accommodation spaces for battery cells, especially in the region of all the accommodation spaces. For this purpose, it is possible, for example, to provide a multitude of safety sections or one or more associated, larger safety wall sections which extend over several accommodation spaces, especially over all the accommodation spaces of the battery module housing.

The material properties and the thickness of the safety wall section are preferably such that the safety wall section, on contact with a flame having a temperature of at least 600° C., has burnt through after not more than 5, preferably not more than 4 and especially not more than 3 seconds, such that a hole forms in this region in the battery module housing. The reported temperature of the flame is the temperature of the flame at the surface of the safety wall section.

The hole which forms in this region in the battery module housing is understood to mean a continuous hole which extends through the entire battery module housing wall, such that the energy from a flame which escapes from the battery cell disposed in a corresponding accommodation space is conducted out of the battery module housing.

The hole which forms in the safety wall section preferably has a diameter of at least 5 mm, especially at least 10 mm.

Preferably, the diameter of the safety wall section is not more than 25 mm. The area of the safety wall section is preferably not more than 800 mm² and/or preferably less than 20%, more preferably less than 12%, of the total area of the battery module housing takes the form of the safety wall section.

In the inventive battery module, the battery module housing has, on the battery module interior side, i.e. on the inside of the battery module housing, accommodation spaces for a given number of battery cells.

Battery modules, especially battery modules for electrical vehicles, typically have a given number of battery cells which are integrated into the battery module. Typically, battery cells are connected in series in a battery module, and so the output voltage of the battery module is the product of the battery cell voltage and the number of battery cells connected in series. Since battery modules have to have a given output voltage, this also defines the number of battery cells in the battery module. Accordingly, the size of the battery module is adjusted such that it can accommodate the given number of battery cells. Typical battery modules have, for example, between 8 and 36, especially between 12 and 36, battery cells.

An accommodation space for a battery cell in the battery module interior is especially designed such that the accommodation space can accommodate a battery cell, for example a battery cell of the 18650 type. This type comprises essentially cylindrical battery cells having a diameter of about 18.6 mm and a height of about 65.2 mm. Accommodation spaces adapted to these battery cells may have, for example, a round accommodation region having a diameter exceeding the battery cell diameter of 18.6 mm by an allowance for interference.

As well as battery cells of the 18650 type, the battery module can also be designed for other types of battery cells, for example for battery cells corresponding to one of the following types: 10180, 10280, 10440, 14250, 14500, 14560, 15270, 16340, 17340, 17500, 17670, 18350, 18500, 19670, 25500, 26650 or 32600. For this purpose, the accommodation spaces may have, for example, a diameter exceeding the battery cell by matter of the appropriate type by an allowance for interference. In addition, the battery module may also be designed for what are called coffee-bag battery cells, i.e., flat rectangular battery cells.

Preferably, the accommodation space is configured such that a battery cell can be fixed in a form-fitting and/or force-fitting manner in the accommodation space, in order to prevent slippage or movement of the battery cell in normal operation. In addition, the accommodation space may have connection means in order to connect the battery cell to an electrical circuit, especially to connect it in series with further battery cells.

In one embodiment of the battery module, the safety wall section is disposed in a region of the accommodation space designed to accommodate the underside of a battery cell.

Preferential fracture sites in battery cells, especially in lithium ion accumulators, for example of the 18650 type, are frequently disposed on the underside of the battery cell, such that, in the event of damage, a flame escapes from the underside of the battery cell in a controlled manner. Through the arrangement of the safety wall section in a region of the accommodation space designed to accommodate the underside of a battery cell, the positioning of the safety wall section is matched to these kinds of battery cells, such that any flame escaping from the battery cell directly hits the safety wall section and then burns through it within the given time.

The region of the accommodation space designed to accommodate the underside of a battery cell preferably has a recess or a border with a preferably essentially circular cross section to accommodate the battery cells, especially to accommodate frequently used cylindrical battery cells.

In a further embodiment of the battery module, the safety wall section is disposed in a region of the accommodation space designed to accommodate an edge region of a battery cell. This embodiment is especially suitable for what are called coffee-bag battery cells, which typically have, in the edge region thereof, a preferential fracture site for escape of a flame in the event of damage.

In one embodiment of the battery module, at least the safety wall section, preferably the entire battery module housing or essentially the entire battery module housing, comprises a flame-retardant material, especially a flame-retardant plastic.

A flame-retardant material, especially a flame-retardant plastic, is understood in the present context to mean a material which can melt and possibly even burn if a flame is acting on it, but which does not bum any further after the flame has been extinguished. The use of such a material can prevent the safety section or the battery module housing from continuing to burn after any flame which escapes from a battery cell has been extinguished. This can prevent the spread of a tire. More particularly, a flame-retardant material is understood in the present context to mean a material which meets the prerequisites of the UL 94-V (bar) test. The UL 94-V (bar) test is an Underwriters Laboratories test from the UL 94 method (“Tests for Flammability of Plastic Materials for Parts in Devices and Applications”). Preferably, the flame-retardant material fulfils the V-2 classification, preferably the V-1 classification, especially the V-0 classification, in the UL 94-V (bar) test.

Preferably, the material, especially the flame-retardant material, encompassed by the safety wall section fulfils the 5VB classification in the UL 94-5VB (plaque) test, with formation of a fire hole.

The aforementioned UL tests are also disclosed in a corresponding manner by DIN EN 60695-11-10 and DIN EN 60695-11-20.

In a further embodiment of the battery module, at least the safety wall section, preferably the entire battery module housing or essentially the entire battery module housing, comprises a polycarbonate material.

Polycarbonate materials are notable for a good elasticity and high toughness, especially also at low temperatures down to −30° C., which can quite possibly occur in the case of use in electrical vehicles. In addition, polycarbonate materials can be provided with good flame retardancy.

Useful polycarbonate materials in the present context are especially polycarbonate compositions containing
A) 70.0 to 90.0 parts by weight, preferably 75.0 to 88.0 parts by weight, more preferably 77.0 to 85.0 parts by weight (based on the sum total of the parts by weight of components A+B+C) of linear and/or branched aromatic polycarbonate and/or aromatic polyester carbonate,
B) 6.0 to 15.0 parts by weight, preferably 7.0 to 13.0 parts by weight, more preferably 9.0 to 11.0 parts by weight (based on the sum total of the parts by weight of components A+B+C) of at least one graft polymer comprising
   B.1) 5% to 40% by weight, preferably 5% to 30% by weight, more preferably 10% to 20% by weight (based in each case on the graft polymer B) of a shell composed of at least one vinyl monomer and
   B.2) 95% to 60% by weight, preferably 95% to 70% by weight, more preferably 80% to 90% by weight (based in each case on the graft polymer B) of one or more graft bases composed of silicone-acrylate composite rubber,
C) 2.0 to 15.0 parts by weight, preferably 3.0 to 13.0 parts by weight, more preferably 4.0 to 11.0 parts by weight (based on the sum total of the parts by weight of components A+B+C) of phosphorus compounds selected from the groups of mono- and oligomeric phosphoric and phosphonic esters, phosphonate amines, phosphazenes and phosphinates, it also being possible to use mixtures of a plurality of components selected from one of these groups or various groups as flame retardants,
D) 0 to 3.0 parts by weight, preferably 0.01 to 1.00 part by weight, more preferably 0.1 to 0.6 part by weight (based on the sum total of the parts by weight of components A+B+C) of anti-dripping agent,
E) 0-3.0 parts by weight, preferably 0 to 1.0 part by weight (based on the sum total of the parts by weight of components A+B+C) of thermoplastic vinyl (co)polymer (E.1) and/or polyalkylene terephthalate (E.2), the composition more preferably being free of thermoplastic vinyl (co)polymers (E.1) and/or polyalkylene terephthalates (E.2), and
F) 0 to 20.0 parts by weight, preferably 0.1 to 10.0 parts by weight, more preferably 0.2 to 5.0 parts by weight (based on the sum total of the parts by weight of components A+B+C) of further additives,
   where the compositions are preferably free of rubber-free polyalkyl(alkyl)acrylate, and where all the parts by weight stated in the present application are normalized such that the sum total of the parts by weight of components A+B+C in the composition adds up to 100.

Further useful polycarbonate materials in the present context are especially polycarbonate compositions containing
A) 70.0 to 90.0 parts by weight, preferably 75.0 to 88.0 parts by weight, more preferably 77.0 to 85.0 parts by weight (based on the sum total of the parts by weight of components A+B*+C) of linear and/or branched aromatic polycarbonate and/or aromatic polyester carbonate,
B) 6.0 to 15.0 parts by weight, preferably 7.0 to 13.0 parts by weight, more preferably 9.0 to 11.0 parts by weight (based on the sum total of the parts by weight of components A+B*+C) of at least one graft polymer comprising
   B*.1) 5 to 95, preferably 30 to 80, parts by weight of a mixture of
      B*.1.1) 50 to 95 parts by weight of styrene, α-methylstyrene, styrene with methyl substitution on the ring, C₁- to C₈-alkyl methacrylate, especially methyl methacrylate, C₁- to C₈-alkyl acrylate, especially methyl acrylate, or mixtures of these compounds and
      B*.1.2) 5 to 50 parts by weight of acrylonitrile, methacrylonitrile, C₁- to C₈-alkyl methacrylates, especially methyl methacrylate, C₁- to C₈-alkyl acrylate, especially methyl acrylate, maleic anhydride. N—C₁- to C₄-alkyl- or N-phenyl-substituted maleimides or mixtures of these compounds, grafted onto
   B*.2) 5 to 95, preferably 20 to 70, parts by weight of a rubber-containing butadiene- or acrylate-based graft base,
   C) 2.0 to 15.0 parts by weight, preferably 3.0 to 13.0 parts by weight, more preferably 4.0 to 11.0 parts by weight (based on the sum total of the parts by weight of components A+B*+C) of phosphorus compounds selected from the groups of mono- and oligomeric phosphoric and phosphonic esters, phosphonate amines, phosphazenes and phosphinates, it also being possible to use mixtures of a plurality of components selected from one of these groups or various groups as flame retardants,
D) 0 to 3.0 parts by weight, preferably 0.01 to 1.00 part by weight, more preferably 0.1 to 0.6 part by weight (based on the sum total of the parts by weight of components A+B*+C) of anti-dripping agent,
E) 0-3.0 parts by weight, preferably 0 to 1.0 part by weight (based on the sum total of the parts by weight of components A+B*+C) of thermoplastic vinyl (co)polymer (E.1) and/or polyalkylene terephthalate (E.2), the composition more preferably being free of thermoplastic vinyl (co)polymers (E, I) and/or polyalkylene terephthalates (E.2), and
F) 0 to 20.0 parts by weight, preferably 0.1 to 10.0 parts by weight, more preferably 0.2 to 5.0 parts by weight (based on the sum total of the parts by weight of components A+B*+C) of further additives,
   where the compositions are preferably free of rubber-free polyalkyl(alkyl)acrylate, and where all the parts by weight stated in the present application are normalized such that the sum total of the parts by weight of components A+B*+C in the composition adds up to 100.

The individual components of the above-described polycarbonate compositions are elucidated in detail hereinafter:

Component A

Suitable aromatic polycarbonates and/or aromatic polyestercarbonates according to component A are known from the literature or preparable by processes known from the literature (for preparation of aromatic polycarbonates see, for example, Schnell, “Chemistry and Physics of Polycarbonates”, Interscience Publishers, 1964, and also DE-B 1 495 626, DE-A 2 232 877, DE-A 2 703 376, DE-A 2 714 544, DE-A 3 000 610, DE-A 3 832 396; for preparation of aromatic polyestercarbonates, for example DE-A 3 077 934).

Aromatic polycarbonates are prepared, for example, by reacting diphenols with carbonic halides, preferably phosgene, and/or with aromatic dicarbonyl dihalides, preferably benzenedicarbonyl dihalides, by the interfacial process, optionally using chain terminators, for example monophenols, and optionally using trifunctional or more than trifunctional branching agents, for example triphenols or tetraphenols. Preparation is likewise possible via a melt polymerization process through reaction of diphenols with, for example, diphenyl carbonate.

Diphenols for preparation of the aromatic polycarbonates and/or aromatic polyestercarbonates are preferably those of the formula (I)

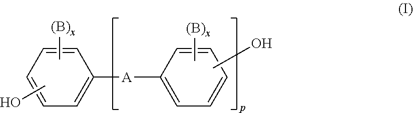

where
A is a single bond, C₁- to C₅-alkylene, C₂- to C₅-alkylidene, C₅- to C₆-cycloalkylidene, —O—, —SO—, —CO—, —S—, —SO₂—, C₆- to C₁₂-arylene, onto which may be fused further aromatic rings optionally containing heteroatoms,
   or a radical of the formula (II) or (III)

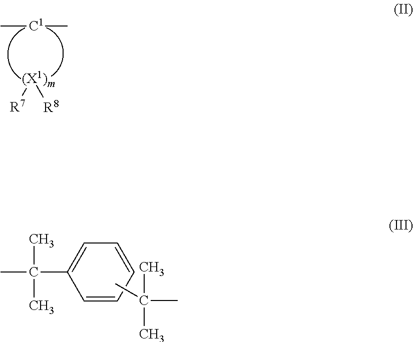

B in each case is C₁- to C₁₂-alkyl, preferably methyl, halogen, preferably chlorine and/or bromine,
x in each case is independently 0. 1 or 2,
p is 1 or 0, and
R⁷ and R⁸ can be chosen individually for each X¹, and are each independently hydrogen or C₁- to C₆-alkyl, preferably hydrogen, methyl or ethyl,
X¹ is carbon and
m is an integer from 4 to 7, preferably 4 or 5, with the proviso that R⁷ and R⁸ on at least one X¹ atom are simultaneously alkyl.

Preferred diphenols are hydroquinone, resorcinol, dihydroxydiphenols, bis(hydroxyphenyl)-C₁- to —C₅-alkanes, bis(hydroxyphenyl)-C₅- to —C₆-cycloalkanes, bis(hydroxyphenyl)ethers, bis(hydroxyphenyl)sulphoxides, bis(hydroxyphenyl)ketones, bis(hydroxyphenyl)sulphones and α,α-bis(hydroxyphenyl)diisopropylbenzenes, and the ring-brominated and/or ring-chlorinated derivatives thereof.

Particularly preferred diphenols are 4,4′-dihydroxydiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxydiphenyl sulphide, 4,4′-dihydroxydiphenyl sulphone and the di- and tetrabrominated or chlorinated derivatives thereof, for hydroxyphenyl)propane or 2,2-bis(3,5-dibromo-4-hydroxyphenyl)propane. 2,2-Bis(4-hydroxyphenyl)propane (bisphenol A) is especially preferred.

It is possible to use the diphenols individually or in the form of any desired mixtures. The diphenols are known from the literature or obtainable by processes known from the literature.

Examples of chain terminators suitable for the preparation of the thermoplastic aromatic polycarbonates include phenol, p-chlorophenol, p-tert-butylphenol or 2,4,6-tribromophenol, but also long-chain alkylphenols such as 4-[2-(2,4,4-trimethylpentyl)]phenol, 4-(1,1,3,3-tetramethylbutyl)phenol according to DE-A 2 842 005 or monoalkylphenol or dialkylphenols having a total of 8 to 20 carbon atoms in the alkyl substituents, such as 3,5-di-tert-butylphenol, p-isooctylphenol, p-tert-octylphenol, p-dodecylphenol and 2-(3,5-dimethylheptyl)phenol and 4-(3,5-dimethylheptyl)phenol. The amount of chain terminators to be used is generally between 0.5 mol % and 10 mol %, based on the molar sum of the diphenols used in each case.

The thermoplastic aromatic polycarbonates have mean weight-average molecular weights (M_{w}, measured by GPC, ultracentrifuge or scattered light measurement) of 10 000 to 200 000 g/mol, preferably 15 000 to 80 000 g/mol, more preferably 24 000 to 32 000 g/mol.

The thermoplastic aromatic polycarbonates may be branched in a known manner, preferably through the incorporation of 0.05 to 2.0 mol %, based on the sum total of the diphenols used, of trifunctional or more than trifunctional compounds, for example those having three or more phenolic groups.

Both homopolycarbonates and copolycarbonates are suitable. For preparation of copolycarbonates in accordance with component A, it is also possible to use 1.0% to 25.0% by weight, preferably 2.5% to 25.0% by weight, based on the total amount of diphenols to be used, of polydiorganosiloxanes having hydroxyaryloxy end groups. These are known (U.S. Pat. No. 3,419,634) and are preparable by processes known from the literature. The preparation of polydiorganosiloxane-containing copolycarbonates is described in DE-A 3 334 782.

Preferred polycarbonates are, as well as the bisphenol A homopolycarbonates, the copolycarbonates of bisphenol A with up to 15 mol %, based on the molar sums of diphenols, of other diphenols specified as preferred or particularly preferred, especially 2,2-bis(3,5-dibromo-4-hydroxyphenyl)propane.

Aromatic dicarbonyl dihalides for preparation of aromatic polyestercarbonates are preferably the diacid dichlorides of isophthalic acid, terephthalic acid, diphenyl ether 4,4′-dicarboxylic acid and naphthalene-2,6-dicarboxylic acid.

Particular preference is given to mixtures of the diacid dichlorides of isophthalic acid and terephthalic acid in a ratio between 1:20 and 20:1.

In the preparation of polyestercarbonates, a carbonic halide, preferably phosgene, is also additionally used as a bifunctional acid derivative.

Useful chain terminators for the preparation of the aromatic polyestercarbonates include, apart from the monophenols already mentioned, the chlorocarbonic esters thereof and the acid chlorides of aromatic monocarboxylic acids, which may optionally be substituted by C₁- to C₂₂-alkyl groups or by halogen atoms, and aliphatic C₂- to C₂₂-monocarbonyl chlorides.

The amount of chain terminators in each case is 0.1 to 10.0 mol %, based on moles of diphenol in the case of the phenolic chain terminators and on moles of dicarbonyl dichloride in the case of monocarbonyl chloride chain terminators.

The aromatic polyestercarbonates may also contain incorporated aromatic hydroxycarboxylic acids. The aromatic polyestercarbonates may be either linear or branched in a known manner (see DE-A 2 940 024 and DE-A 3 007 934).

Branching agents used may, for example, be tri- or multifunctional carbonyl chlorides, such as trimesyl trichloride, cyanuric trichloride, 3,3′,4,4′-benzophenonetetracarbonyl tetrachloride, 1,4,5,8-naphthalenetetracarbonyl tetrachloride or pyromellitic tetrachloride, in amounts of 0.01 to 1.0 mol % (based on dicarbonyl dichlorides used), or tri- or multifunctional phenols, such as phloroglucinol, 4,6-dimethyl-2,4,6-tri(4-hydroxyphenyl)hept-2-ene, 4,6-dimethyl-2,4-6-tri(4-hydroxyphenyl)heptane, 1,3,5 -tri(4-hydroxyphenyl)benzene, 1,1,1-tri(4-hydroxyphenyl)ethane, tri(4-hydroxyphenyl)phenylmethane, 2,2-bis[4,4-bis(4-hydroxyphenyl)cyclohexyl]propane, 2,4-bis(4-hydroxyphenylisopropyl)phenol, tetra(4-hydroxyphenyl)methane, 2,6-bis(2-hydroxy-5-methylbenzyl)-4-methylphenol, 2-(4-hydroxyphenyl)-2-(2,4-dihydroxyphenyl)propane, tetra(4-[4-hydroxyphenylisopropyl]phenoxy)methane, 1,4-bis[4,4′-dihydroxytriphenyl)methyl]benzene, in amounts of 0.01 to 1.00 mol %, based on diphenols used. Phenolic branching agents may be initially charged together with the diphenols; acid chloride branching agents may be introduced together with the acid dichlorides.

The proportion of carbonate structural units in the thermoplastic aromatic polyestercarbonates may vary as desired. Preferably, the proportion of carbonate groups is up to 100 mol %, especially up to 80 mol %, more preferably up to 50 mol %, based on the sum total of ester groups and carbonate groups. Both the ester fraction and the carbonate fraction of the aromatic polyestercarbonates may be present in the form of blocks or in random distribution in the polycondensate.

The relative solution viscosity (ηᵣₑₗ) of the aromatic polycarbonates and polyester carbonates is in the range of 1.18 to 1.40, preferably 1.20 to 1.32 (measured on solutions of 0.5 g of polycarbonate or polyestercarbonate in 100 ml of methylene chloride solution at 25° C.).

The thermoplastic aromatic polycarbonates and polyestercarbonates may be used alone or in any desired mixture.

Component B

The graft polymers B are prepared by free-radical polymerization, for example by emulsion, suspension, solution or bulk polymerization, preferably by emulsion polymerization.

Suitable monomers B.1 are vinyl monomers such as vinylaromatics and/or ring-substituted vinylaromatics (such as styrene, α-methylstyrene, p-methylstyrene, p-chlorostyrene), (C₁- to C₈)-alkyl methacrylates (such as methyl methacrylate, ethyl methacrylate, 2-ethylhexyl methacrylate, allyl methacrylate), (C₁- to C₈)-alkyl acrylates (such as methyl acrylate, ethyl acrylate, n-butyl acrylate, t-butyl acrylate), organic acids (such as acrylic acid, methacrylic acid) and/or vinyl cyanides (such as acrylonitrile and methacrylonitrile) and/or derivatives (such as anhydrides and imides) of unsaturated carboxylic acids (for example maleic anhydride and N-phenylmaleimide). These vinyl monomers can be used alone or in mixtures of at least two monomers.

Preferred monomers B.1 are selected from at least one of the monomers styrene, α-methylstyrene, methyl methacrylate, n-butyl acrylate and acrylonitrile. More preferably, the monomer B.1 used is methyl methacrylate.

The glass transition temperature of the graft base B.2 is <10° C. preferably <0° C., more preferably <−20° C. The graft base B.2 generally has a median particle size (d₅₀) of 0.05 to 10 μm, preferably 0.06 to 5 μm, more preferably 0.08 to 1 μm.

The glass transition temperature is measured by means of dynamic differential thermoanalysis (DSC) to the standard DIN EN 61006 at a heating rate of 10 K/min, with definition of the T_{g} as the midpoint temperature (tangent method).

The median particle size d₅₀ is the diameter with 50% by weight of the particles above it and 50% by weight below it. It can be determined by means of ultracentrifuge measurement (W. Scholtan, H. Lange, Kolloid-Z. und Z. Polymere 250 (1972), 782-796).

The graft base B.2 used is silicone-acrylate composite rubber. These silicone-acrylate composite rubbers are preferably composite rubbers having graft-active sites, containing 10%-90% by weight, preferably 30%-85% by weight, of silicone rubber component and 90% to 10% by weight, preferably 70%-15% by weight, of polyalkyl(meth)acrylate rubber component, where these two rubber components penetrate one another in the composite rubber, such that they are essentially inseparable.

If the proportion of the silicone rubber component in the composite rubber is too high, the finished resin compositions have disadvantageous surface properties and poor colourability. If, in contrast, the proportion of the polyalkyl(meth)acrylate rubber component in the composite rubber is too high, the impact resistance of the finished resin composition is adversely affected.

Silicone-acrylate composite rubbers are known and are described, for example, in U.S. Pat. No. 5,807,914, EP 430134 and U.S. Pat. No. 4,888,388.

Suitable silicone rubber components B.2.1 of the silicone-acrylate composite rubbers according to B.2 are silicone rubbers having graft-active sites, the preparation method for which is described, for example, in U.S. Pat. No. 2,891,920, U.S. Pat. No. 3,294,725, DE-A 3 631 540, EP 249964, EP 430134 and U.S. Pat. No. 4,888,388.

The silicone rubber according to B.2.1 is preferably produced by emulsion polymerization, in which siloxane monomer units, crosslinking or branching agents (IV) and optionally grafting agent (V) are used.

Siloxane monomer units used are, for example and with preference, dimethylsiloxane or cyclic organosiloxanes having at least 3 ring members, preferably 3 to 6 ring members, for example and with preference hexamethylcyclotrisiloxane, octamethylcyclotetrasiloxane, decamethylcyclopentasiloxane, dodecamethylcyclohexasiloxane, trimethyltriphenylcyclotrisiloxanes, tetramethyltetraphenylcyclotetrasiloxanes, octaphenylcyclotetrasiloxane.

The organosiloxane monomers can be used alone or in the form of mixtures having 2 or more monomers. The silicone rubber contains preferably not less than 50% by weight and more preferably not less than 60% by weight of organosiloxane, based on the total weight of the silicone rubber component.

Crosslinking or branching agents (IV) used are preferably silane-based crosslinking agents have a functionality of 3 or 4, more preferably 4. Preferred examples include: trimethoxymethylsilane, triethoxyphenylsilane, tetramethoxysilane, tetraethoxysilane, tetra-n-propoxysilane and tetrabutoxysilane. The crosslinking agent can be used alone or in a mixture of two or more. Particular preference is given to tetraethoxysilane.

The crosslinking agent is used within a range of amounts between 0.1% and 40.0% by weight, based on the total weight of the silicone rubber component. The amount of crosslinking agent is selected such that the degree of swelling of the silicone rubber, measured in toluene, is between 3 and 30, preferably between 3 and 25 and more preferably between 3 and 15. The degree of swelling is defined as the weight ratio between the amount of toluene which is absorbed by the silicone rubber when it is saturated with toluene at 25° C. and the amount of silicone rubber in the dried state. The determination of the degree of swelling is described in detail in EP 249964.

If the degree of swelling is less than 3, i.e. if the content of crosslinking agent is too high, the silicone rubber does not exhibit sufficient rubber elasticity. If the swelling index is greater than 30, the silicone rubber cannot form a domain structure in the matrix polymer and therefore cannot give any improvement in impact resistance either; the effect would then be similar to a simple addition of polydimethylsiloxane.

Tetrafunctional crosslinking agents are preferable over trifunctional crosslinking agents, because the degree of swelling is then controllable in a simpler manner within the above-described limits.

Suitable grafting agents (V) are compounds capable of forming structures of the following formulae:

CH₂═C(R⁹)—COO—(CH₂)ₚ—SiR¹⁰ₙO_{(3-n)/2} (V-1)

CH₂═CH—SiR¹⁰ₙO_{(3-n)/2} (V-2) or

HS—(CH₂)ₚ—SiR¹⁰ₙO_{(3-n)/2} (V-3),

where
R⁹ is hydrogen or methyl,
R¹⁰ is C₁- to C₄-alkyl, preferably methyl, ethyl or propyl, or phenyl,
n is 0, 1 or 2 and
p is an integer from 1 to 6.

Acryloyl- or methacryloyloxysilanes are particularly suitable for forming the abovementioned structure (V-1), and have a high grafting efficiency. This assures effective formation of the graft chains, and hence promotes the impact resistance of the resulting resin composition.

Preferred examples include: β-methacryloyloxyethyldimethoxymethylsilane, γ-methacryloyloxypropylmethoxydimethylsilane, γ-methacryloyloxypropyldimethoxymethylsilane, γ-methacryloyloxypropyltrimethoxysilane, γ-methacryloyloxypropylethoxydiethylsilane, γ-methacryloyloxypropyldiethoxymethylsilane, δ-methacryloyloxybutyldiethoxymethylsilane or mixtures thereof.

Preferably, 0% to 20% by weight of grafting agent is used, based on the total weight of the silicone rubber.

The silicone rubber can be prepared by emulsion polymerization, as described, for example, in U.S. Pat. No. 2,891,920 and U.S. Pat. No. 3,294,725. The silicone rubber is obtained in the form of an aqueous latex. For this purpose, a mixture comprising organosiloxane, crosslinking agent and optionally grafting agent is mixed with water under shear, for example by means of a homogenizer, in the presence of a sulphonic acid-based emulsifier, for example alkylbenzenesulphonic acid or alkyl sulphonic acid, the mixture being polymerized to completion to give the silicone rubber latex. An alkylbenzenesulphonic acid is particularly suitable, since it acts not just as an emulsifier but also as a polymerization initiator. In this case, a combination of the sulphonic acid with a metal salt of an alkylbenzenesulphonic acid or with a metal salt of an alkylsulphonic acid is favourable, because this stabilizes the polymer during the later graft polymerization.

After the polymerization, the reaction is ended by neutralizing the reaction mixture through addition of an aqueous alkaline solution, for example through addition of an aqueous sodium hydroxide, potassium hydroxide or sodium carbonate solution.

Suitable polyalkyl(meth)acrylate rubber components B.2.2 of the silicone-acrylate composite rubbers according to B.2 may be prepared from alkyl methacrylates and/or alkyl acrylates, a crosslinking agent (IV) and a grafting agent (V). In this context, preferred examples of alkyl methacrylates and/or alkyl acrylates are the C₁- to —C₈-alkyl esters, for example methyl, ethyl, n-butyl, t-butyl, n-propyl, n-hexyl, n-octyl, n-lauryl and 2-ethylhexyl esters; haloalkyl esters, preferably halo-C₁- to —C₈-alkyl esters, such as chloroethyl acrylate, and mixtures of these monomers. Particular preference is given to n-butyl acrylate.

Crosslinking agents (IV) used for the polyalkyl(meth)acrylate rubber component of the silicone-acrylate rubber may be monomers having more than one polymerizable double bond. Preferred examples of crosslinking monomers are esters of unsaturated monocarboxylic acids having 3 to 8 carbon atoms and unsaturated monohydric alcohols having 3 to 12 carbon atoms, or of saturated polyols having 2 to 4 OH groups and 2 to 20 carbon atoms, for example ethylene glycol dimethacrylate, propylene glycol dimethacrylate, 1,3-butylene glycol dimethacrylate and 1,4-butylene glycol dimethacrylate. The crosslinking agents can be used alone or in mixtures of at least two crosslinking agents.

Preferred examples of grafting agents (V) are allyl methacrylate, triallyl cyanurate, triallyl isocyanurate or mixtures thereof. Allyl methacrylate can also be used as crosslinking agent (IV). The grafting agents can be used alone or in mixtures of at least two grafting agents.

The amount of crosslinking agent (IV) and grafting agent (V) is 0.1% to 20% by weight, based on the total weight of the polyalkyl(meth)acrylate rubber component of the silicone-acrylate rubber.

The silicone-acrylate composite rubber is prepared by first preparing the silicone rubber according to B.2.1 as an aqueous latex. This latex is subsequently supplemented with the alkyl methacrylates and/or alkyl acrylates to be used, the crosslinking agent (IV) and the grafting agent (V), and a polymerization is conducted. Preference is given to a free-radically initiated emulsion polymerization, for example one initiated by a peroxide, azo or redox initiator. Particular preference is given to the use of a redox initiator system, specifically of a sulphoxylate system, prepared by combination of iron sulphate, disodium ethylenediaminetetraacetate, Rongalit and hydroperoxide.

The effect of the grafting agent (V) which is used in the preparation of the silicone rubber is that the polyalkyl(meth)acrylate rubber component is attached covalently to the silicone rubber component. In the polymerization, the two rubber components penetrate one another and thus form the composite rubber which, after the polymerization, cannot be separated again into its constituents of silicone rubber component and polyalkyl(meth)acrylate rubber component.

For preparation of the silicone-acrylate composite graft rubbers B specified as component B), the monomers B.1 are grafted onto the rubber base B.2.

This can be done by employing the polymerization methods described, for example, in EP 249964, EP 430134 and U.S. Pat. No. 4,888,388.

For example, the graft polymerization is effected by the following polymerization method: In a one-stage or multistage free-radically initiated emulsion polymerization, the desired vinyl monomers B.1 are polymerized onto the graft base, which is in the form of an aqueous latex. The grafting efficiency should be at a maximum and is preferably greater than or equal to 10%. The grafting efficiency depends crucially on the grafting agent (V) used. After the polymerization to give the silicone(-acrylate) graft rubber, the aqueous latex is added to hot water in which metal salts have been dissolved beforehand, for example calcium chloride or magnesium sulphate. This coagulates the silicone(-acrylate) graft rubber, and it can subsequently be separated.

The alkyl methacrylate and alkyl acrylate graft rubbers specified as component B) are commercially available. Examples include: Metablen® SX 005, Metablen® S-2030 and Metablen® SRK 200 from Mitsubishi Rayon Co. Ltd.

Component B*

The graft polymers B* are prepared by free-radical polymerization, for example by emulsion, suspension, solution or bulk polymerization, preferably by emulsion polymerization.

The graft polymers B* comprise, for example, graft polymers having elastomeric properties, obtainable essentially from at least 2 of the following monomers: chloroprene, 1,3-butadiene, isoprene, styrene, acrylonitrile, ethylene, propylene, vinyl acetate and (meth)acrylic esters having 1 to 18 carbon atoms in the alcohol component, i.e. polymers as described, for example, in “Methoden der Organischen Chemie” [Methods of Organic Chemistry] (Houben-Weyl), vol. 14/1, Georg Thieme-Verlag, Stuttgart 1961, p. 393-406 and in C. B. Bucknall, “Toughened Plastics”, Appl. Science Publishers, London 1977. Preferred polymers B* are partially crosslinked and have gel contents (measured in toluene) of more than 20% by weight, preferably more than 40% by weight, especially more than 60% by weight.

The gel content is determined at 25° C. in a suitable solvent (M. Hoffmann, H. Krömer, R. Kuhn, Polymeranalytik I und II [Polymer Analysis I and II], Georg Thieme-Verlag, Stuttgart 1977).

Preferred graft polymers B* comprise graft polymers composed of:
B*.1) 5 to 95, preferably 30 to 80, parts by weight of a mixture of
   B*.1.1) 50 to 95 parts by weight of styrene, α-methylstyrene, styrene with methyl substitution on the ring, C₁- to C₈-alkyl methacrylate, especially methyl methacrylate, C₁- to C₈-alkyl acrylate, especially methyl acrylate, or mixtures of these compounds and
   B*.1.2) 5 to 50 parts by weight of acrylonitrile, methacrylonitrile, C₁- to C₈-alkyl methacrylates, especially methyl methacrylate, C₁- to C₈-alkyl acrylate, especially methyl acrylate, maleic anhydride, N—C₁- to C₄- or N-phenyl-substituted maleimides or mixtures of these compounds, grafted onto
B*.2) 5 to 95, preferably 20 to 70, parts by weight of a rubber-containing graft base.

Preferably, the graft base has a glass transition temperature below −10° C.

More preferably, the graft base is based on a polybutadiene rubber.

The glass transition temperature is measured by means of dynamic differential thermoanalysis (DSC) to the standard DIN EN 61006 at a heating rate of 10 K/min, with definition of the T_{g} as the midpoint temperature (tangent method).

Preferred graft polymers B* are, for example, polybutadienes grafted with styrene and/or acrylonitrile and/or alkyl (meth)acrylates, butadiene/styrene copolymers and acrylate rubbers, i.e. copolymers of the type described in DE-A 1 694 173 (=U.S. Pat. No. 3,564,077), polybutadienes grafted with alkyl acrylates or methacrylates, vinyl acetate, acrylonitrile, styrene and/or alkylstyrenes, butadiene/styrene or butadiene/acrylonitrile copolymers, polyisobutenes or polyisoprenes, as described, for example, in DE-A 2 348 377 (=U.S. Pat. No. 3 919 353).

Particularly preferred graft polymers B* are graft polymers obtainable by grafting reaction of
I. 10% to 70%, preferably 15% to 50%, especially 20% to 40%, by weight, based on grafting product, of at least one (meth)acrylic ester, or 10% to 70%, preferably 15% to 50%, especially 20% to 40%, by weight of a mixture of 10% to 50%, preferably 20% to 35%, by weight, based on mixture, of acrylonitrile or (meth)acrylic ester and 50% to 90%, preferably 65% to 80%, by weight, based on mixture, of styrene, grafted onto
II. 30% to 90%, preferably 40% to 85%, especially 50% to 80%, by weight, based on grafting product, of a butadiene polymer having at least 50% by weight, based on II, of butadiene residues as graft base.

The gel content of this graft base II is preferably at least 70% by weight (measured in toluene), the grafting level G is 0.15 to 0.55, and the median particle diameter d₆₀ of the graft polymer B* is 0.05 to 2 μm, preferably 0.1 to 0.6 μm.

(Meth)acrylic esters I are esters of acrylic acid or methacrylic acid and monohydric alcohols having 1 to 18 carbon atoms. Particular preference is given to methyl, ethyl and propyl methacrylate.

The graft base II may, as well as butadiene residues, contain up to 50% by weight, based on II, of residues of other ethylenically unsaturated monomers, such as styrene, acrylonitrile, esters of acrylic or methacrylic acid having 1 to 4 carbon atoms in the alcohol component (such as methyl acrylate, ethyl acrylate, methyl methacrylate, ethyl methacrylate), vinyl esters and/or vinyl ethers. The preferred graft base II consists of pure polybutadiene.

Since, as is well known, the graft monomers are not necessarily grafted completely onto the graft base in the grafting reaction, graft polymers B* are also understood to mean those products which are obtained through polymerization of the graft monomers in the presence of the graft base.

The moulding compositions preferably have a total content of the polymer which has formed from graft monomers or has been added in free form and is not chemically bound to the graft base, for example free SAN, of less than 2.0% by weight, preferably less than 1.5% by weight (i.e. of 0.0%-2.0% by weight, preferably 0.0%-1.5% by weight), based on the overall moulding composition. In the event of an increase in this proportion, the properties worsen drastically.

The grafting level G refers to the weight ratio of graft monomers grafted on relative to the graft base, and is dimensionless.

The median particle size d₅₀ is the diameter with 50% by weight of the particles above it and 50% by weight below it. It can be determined by means of ultracentrifuge measurement (W. Scholtan, H. Lange, Kolloid, Z. und Z. Polymere 250 (1972), 782-796).

Further preferred graft polymers B* are, for example, also graft polymers composed of
(a) 20% to 90% by weight, based on B*, of acrylate rubber as graft base and
(b) 10% to 80% by weight, based on B*, of at least one polymerizable, ethylenically unsaturated monomer that would form, in the absence of a), homo- or copolymers having a glass transition temperature exceeding 25° C., as graft monomers.

The graft base composed of acrylate rubber has a glass transition temperature of less than −20° C., preferably less than −30° C.

The acrylate rubbers (a) of the polymers B* are preferably polymers of alkyl acrylates, optionally with up to 40% by weight, based on (a), of other polymerizable, ethylenically unsaturated monomers. The preferred polymerizable acrylic esters include C₁- to C₈-alkyl esters, for example methyl, ethyl, n-butyl, n-octyl and 2-ethylhexyl esters, and mixtures of these monomers.

For crosslinking, it is possible to copolymerize monomers having more than one polymerizable double bond. Preferred examples of crosslinking monomers are esters of unsaturated monocarboxylic acids having 3 to 8 carbon atoms and unsaturated monohydric alcohols having 3 to 12 carbon atoms or of saturated polyols having 2 to 4 OH groups and 2 to 20 carbon atoms, for example ethylene glycol dimethacrylate, allyl methacrylate; polyunsaturated heterocyclic compounds, for example trivinyl cyanurate and triallyl cyanurate; polyfunctional vinyl compounds, such as di- and trivinylbenzenes, but also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, trivinyl cyanurate, triacryloylhexahydro-s-triazine, triallylbenzenes.

The amount of the crosslinking monomers is preferably 0.02% to 5.00%, especially 0.05% to 2.00%, by weight, based on graft base (a).

In the case of cyclic crosslinking monomers having at least 3 ethylenically unsaturated groups, it is advantageous to restrict the amount to below 1% by weight of the graft base (a).

Preferred “other” polymerizable, ethylenically unsaturated monomers which, alongside the acrylic esters, may optionally serve for preparation of the graft base (a) are, for example, acrylonitrile, styrene, α-methylstyrene, acrylamide, vinyl C₁-C₆-alkyl ethers, methyl methacrylate, butadiene.

Preferred acrylate rubbers as graft base (a) are emulsion polymers having a gel content of at least 60% by weight.

Component C

The compositions also contain flame retardants, these preferably being selected from the group comprising phosphorus flame retardants and halogenated flame retardants.

Particular preference is given to using phosphorus flame retardants, these phosphorus flame retardants being selected from the groups of the mono- and oligomeric phosphoric and phosphonic esters, phosphonate amines, phosphazenes and phosphinic salts, and it is also possible to use mixtures of a plurality of components selected from one or more than one of these groups as flame retardants. It is also possible to use other halogen-free phosphorus compounds that have not been mentioned here specifically, alone or in any desired combination with other halogen-free phosphorus compounds.

Preferred mono- and oligomeric phosphoric and phosphonic esters are phosphorus compounds of the general formula (VI)

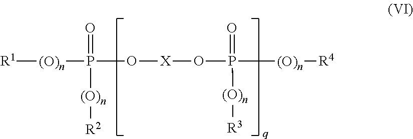

in which
R¹, R², R³ and R⁴ are each independently optionally halogenated C₁- to C₈-alkyl, in each case optionally alkyl-substituted, preferably C₁- to C₄-alkyl- and/or halogen-substituted, preferably chlorine- or bromine-substituted, C₅- to C₆-cycloalkyl, C₆- to C₂₀-aryl or C₇- to C₁₂-aralkyl,
n is independently 0 or 1,
q is 0 to 30 and
X is a mono- or polycyclic aromatic radical having 6 to 30 carbon atoms, or a linear or branched aliphatic radical having 2 to 30 carbon atoms, which may be OH-substituted and may contain up to eight ether bonds.

Preferably, R¹, R², R³ and R⁴ are each independently C₁- to C₄-alkyl, phenyl, naphthyl or phenyl-C₁- to C₄-alkyl. The aromatic R¹, R², R³ and R⁴ groups may in turn be substituted by halogen and/or alkyl groups, preferably chlorine, bromine and/or C₁- to C₄-alkyl. Particularly preferred aryl radicals are cresyl, phenyl, xylenyl, propylphenyl or butylphenyl, and the corresponding brominated and chlorinated derivatives thereof.
X in the formula (VI) is preferably a mono- or polycyclic aromatic radical having 6 to 30 carbon atoms. The latter preferably derives from diphenols of the formula (1).
n in the formula (VI) may independently be 0 or 1; n is preferably 1.
q (in formula VII as well) is integers from 0 to 30, preferably 0 to 20, more preferably 0 to 10, and in the case of mixtures is average values of 0.8 to 5.0, preferably 1.0 to 3.0, further preferably 1.05 to 2.00, and more preferably of 1.08 to 1.60.
X is more preferably

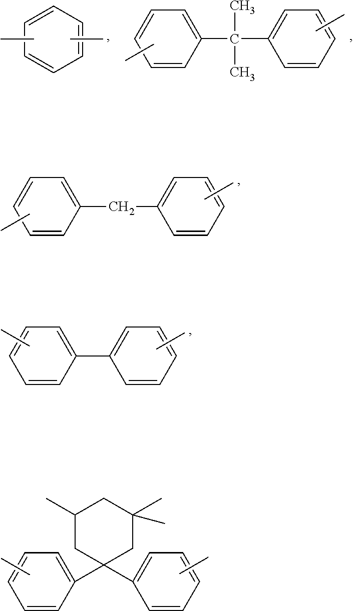

or the chlorinated or brominated derivatives thereof; more particularly, X derives from resorcinol, hydroquinone, bisphenol A or diphenylphenol. More preferably, X derives from bisphenol A.

Phosphorus compounds of the formula (VI) are especially tributyl phosphate, triphenyl phosphate, tricresyl phosphate, diphenyl cresyl phosphate, diphenyl octyl phosphate, diphenyl 2-ethylcresyl phosphate, tri(isopropylphenyl) phosphate, resorcinol-bridged oligophosphate and bisphenol A-bridged oligophosphate. The use of oligomeric phosphoric esters of the formula (VI) which derive from bisphenol A is especially preferred.

Most preferred as component C is bisphenol A-based oligophosphate of formula (VIa)

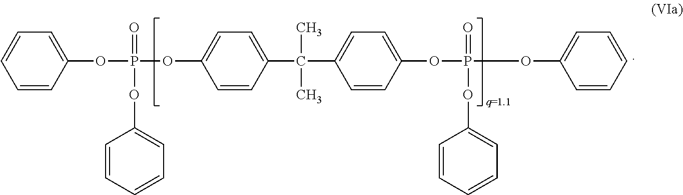

In an alternative preferred embodiment, component C is rorcinol-based oligophosphate of formula (VIb)

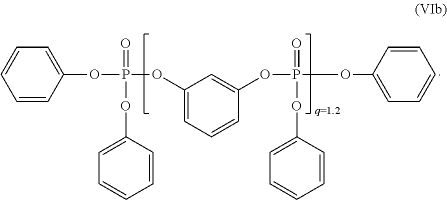

The phosphorus compounds according to component C are known (cf., for example, EP-A 363 608, EP-A 640 655) or can be prepared in an analogous manner by known methods (e.g. Ullmanns Enzyklopädie der technischen Chemie [Ullmann's Encyclopedia of Industrial Chemistry], vol. 18, p. 301 ff. 1979; Houben-Weyl, Methoden der organischen Chemie, vol. 12/1, p. 43; Beilstein vol. 6, p. 177).

As component C, it is also possible to use mixtures of phosphates having different chemical structure and/or having the same chemical structure and different molecular weight.

Preferably, mixtures having the same structure and different chain length are used, in which case the q value reported is the mean q value. The mean q value can be determined by using a suitable method (gas chromatography (GC), high pressure liquid chromatography (HPLC), gel permeation chromatography (GPC)) to determine the composition of the phosphorus compound (molecular weight distribution) and using this to calculate the mean values for q.

In addition, it is possible to use phosphonate amines and phosphazenes as described in WO 00/00541 and WO 01/18105 as flame retardants.

The flame retardants can be used alone or in any desired mixture with one another, or in a mixture with other flame retardants.

Further preferred flame retardants are salts of a phosphinic acid with any desired metal cations. It is also possible to use mixtures of salts which differ in terms of their metal cations. The metal cations are the cations of the metals of main group 1 (alkali metals, preferably Li⁺, Na⁺, K⁺), of main group 2 (alkaline earth metals, preferably Mg²⁺, Ca²⁺, Sr²⁺, Ba²⁺, more preferably Ca²⁺) or of main group 3 (elements of the boron group, preferably Al³⁺) and/or of transition group 2, 7 or 8 (preferably Zn²⁺, Mn²⁺, Fe²⁺, Fe³⁺) of the Periodic Table.

Preferably, a salt or a mixture of salts of a phosphinic acid of the formula (IX) is used

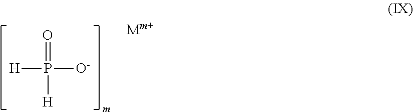

in which M^{m+} is a metal cation of main group 1 (alkali metals; m=1), of main group 2 (alkaline earth metals; in=2) or of main group 3 (m=3) or of transition group 2, 7 or 8 (where m is an integer from 1 to 6, preferably 1 to 3 and more preferably 2 or 3) of the Periodic Table.

More preferably, in formula (IX),

when m=1 the metal cations M⁺=Li⁺, Na⁺, K⁺,

when m=2 the metal cations M²⁺=Mg²⁺, Ca²⁺, Sr²⁺, Ba²⁺ and

when m=3 the metal cation M³⁺=Al;

most preferably, Ca²⁺ (m=2) and Al³⁺ (m=3).

In a preferred embodiment, the median particle size d₅₀ of the phosphinic salt (component C) is less than 80 μm, preferably less than 60 μm; more preferably, d₅₀ is between 10 μm and 55 μm. The median particle size d₅₀ is the diameter with 50% by weight: of the particles above it and 50% by weight below it. It is also possible to use mixtures of salts which differ in terms of their median particle size d₅₀.

These demands on the particle size are each associated with the technical effect that the fire retardant efficiency of the phosphinic salt is increased.

The phosphinic salt can be used either alone or in combination with other phosphorus flame retardants.

Component D

As anti-dripping agents, the compositions may preferably contain fluorinated polyolefins D. Fluorinated polyolefins are common knowledge (cf., for example, EP-A 640 655). An example of a commercial product is Teflon® 30 N from DuPont.

The fluorinated polyolefins can also be used in the form of a coagulated mixture of emulsions of the fluorinated polyolefins with emulsions of the graft polymers B) or B*) or an emulsion of a copolymer E.1), preferably based on styrene/acrylonitrile or on polymethylmethacrylate, in which case the fluorinated polyolefin is mixed as an emulsion with an emulsion of the graft polymer or (co)polymer and then coagulated.

In addition, the fluorinated polyolefins can also be used in the form of a pre-compound with the graft polymer B) or a copolymer E.1), preferably based on styrene/acrylonitrile or on polymethylmethacrylate. The fluorinated polyolefins in powder form are mixed with a powder or granules of the graft polymer or copolymer, and compounded in the melt, generally at temperatures of 200 to 330° C., in customary pieces of apparatus such as internal kneaders, extruders or twin-shaft screws.

The fluorinated polyolefins can also be used in the form of a masterbatch which is produced by emulsion polymerization of at least one monoethylenically unsaturated monomer in the presence of an aqueous dispersion of the fluorinated polyolefin. Preferred monomer components are styrene, acrylonitrile, polymethylmethacrylate and mixtures thereof. The polymer is used in the form of a free-flowing powder after acidic precipitation and subsequent drying.

The coagulates, pre-compounds or masterbatches typically have solids contents of fluorinated polyolefin of 5% to 95% by weight, preferably 7% to 60% by weight.

Component E

Component E comprises one or more thermoplastic vinyl (co)polymers E.1 and/or polyalkylene terephthalates E.2.

Suitable vinyl (co)polymers F.1 are polymers of at least one monomer from the group of the vinylaromatics, vinyl cyanides (unsaturated nitriles), unsaturated carboxylic acids and derivatives (such as esters, anhydrides and imides) of unsaturated carboxylic acids. Especially suitable are (co)polymers of
E.1.1 50 to 99, preferably 60 to 80, parts by weight of vinylaromatics and/or ring-substituted vinylaromatics (such as styrene, a.-methylstyrene, p-methylstyrene, p-chlorostyrene), and
E.1.2 1 to 50, preferably 20 to 40, parts by weight of vinyl cyanides (unsaturated nitriles such as acrylonitrile and methacrylonitrile) and/or unsaturated carboxylic acids (such as acrylic acid and maleic acid) and/or derivatives (such as anhydrides and imides) of unsaturated carboxylic acids (for example maleic anhydride and N-phenylmaleimide).

The vinyl (co)polymers E.1 are resinous, thermoplastic and rubber-free. Particular preference is given to the copolymer of E.1.1 styrene and E1.2 acrylonitrile.

The (co)polymers according to E.1 are known and can be prepared by free-radical polymerization, especially by emulsion, suspension, solution or bulk polymerization. The (co)polymers preferably have mean molecular weights. Mw (weight average, determined by light scattering or sedimentation) between 15 000 and 200 000 g/mol.

The polyalkylene terephthalates of component E.2 are reaction products of aromatic dicarboxylic acids or the reactive derivatives thereof, such as dimethyl esters or anhydrides, and aliphatic, cycloaliphatic or araliphatic diols, and mixtures of these reaction products. Preferred polyalkylene terephthalates contain at least 80% by weight, preferably at least 90% by weight, based on the dicarboxylic acid component, of terephthalic acid residues and at least 80% by weight, preferably at least 90% by weight, based on the diol component, of ethylene glycol and/or butane-1,4-diol radicals.

The preferred polyalkylene terephthalates may contain, as well as terephthalic acid residues, up to 20 mol %, preferably up to 10 mol %, of residues of other aromatic or cycloaliphatic dicarboxylic acids having 8 to 14 carbon atoms or of aliphatic dicarboxylic acids having 4 to 12 carbon atoms, for example residues of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred polyalkylene terephthalates may contain, as well as ethylene glycol and/or butane-1,4-diol residues, up to 20 mol %, preferably up to 10 mol %, of other aliphatic diols having 3 to 12 carbon atoms or cycloaliphatic diols having 6 to 21 carbon atoms, for example residues of propane-1,3-diol, 2-ethylpropane-1,3-diol, neopentyl glycol, pentane-1,5-diol, hexane-1,6-diol, cyclohexane-1,4-dimethanol, 3-ethylpentane-2,4-diol, 2-methylpentane-2,4-diol, 2,2,4-trimethylpentane-1,3-diol, 2 -ethylhexane-1,3-diol, 2,2-diethylpropatie-1,3-diol, hexane-2,5-diol, 1,4-di(3-hydroxyethoxy)benzene, 2,2-bis(4-hydroxycyclohexyl)propane, 2,4-dihydroxy-1,1,3,3-tetramethylcyclobutane, 2,2-bis(4-β-hydroxyethoxyphenyl)propane and 2,2-bis(4-hydroxypropoxyphenyl)propane (DE-A 2 407 674, 2 407 776, 2 715 932).

The polyalkylene terephthalates may be branched through incorporation of relatively small amounts of tri- or tetrahydric alcohols or tri- or tetrabasic carboxylic acids, for example according to DE-A 1 900 270 and U.S. Pat. No. 3,692,744. Examples of preferred branching agents are trimesic acid, trimellitic acid, trimethylolethane and trimethylolpropane, and pentaerythritol.

Particular preference is given to polyalkylene terephthalates which have been prepared solely from terephthalic acid and the reactive derivatives thereof (e.g., the dialkyl esters thereof) and ethylene glycol and/or butane-1,4-diol, and to mixtures of these polyalkylene terephthalates.

Mixtures of polyalkylene terephthalates contain 1% to 50% by weight, preferably 1% to 30% by weight, of polyethylene terephthalate and 50% to 99% by weight, preferably 70% to 99% by weight, of polybutylene terephthalate.

The polyalkylene terephthalates used with preference generally have a limiting viscosity of 0.4 to 1.5 dl/g, preferably 0.5 to 1.2 dl/g, measured in phenol/o-dichlorobenzene (1:1 part by weight) at 25° C. in an Ubbelohde viscometer.

The polyalkylene terephthalates can be prepared by known methods (see, for example, Kunststoff-Handbuch [Plastics Handbook], volume VIII, p. 695 et seq., Carl-Hanser-Verlag, Munich 1973).

Further Additives F

The moulding compositions may contain at least one further additive among the customary additives, for example lubricants and demoulding agents, nucleating agents, antistats, stabilizers, dyes and pigments, and also fillers and reinforcers.

Component F also comprises ultrafinely divided inorganic compounds which feature an average particle diameter of less than or equal to 200 nm, preferably less than or equal to 150 nm, especially from 1 to 100 nm. Suitable ultrafinely divided inorganic compounds preferably consist of at least one polar compound of one or more metals of main groups 1 to 5 or transition groups 1 to 8 of the Periodic Table, preferably of main groups 2 to 5 or transition groups 4 to 8, more preferably of main groups 3 to 5 or transition groups 4 to 8, or of compounds of these metals with at least one element selected from oxygen, hydrogen, sulphur, phosphorus, boron, carbon, nitrogen or silicon. Preferred compounds are, for example, oxides, hydroxides, water-containing oxides, sulphates, sulphites, sulphides, carbonates, carbides, nitrates, nitrites, nitrides, borates, silicates, phosphates, hydrides, phosphites or phosphonates. Preferably, the ultrafinely divided inorganic compounds consist of oxides, phosphates, hydroxides, preferably of TiO₂, SiO₂, SnO₂, ZnO, ZnS, boehmite, ZrO₂, Al₂O₃, aluminium phosphates, iron oxides, and also TiN, WC, AlO(OH), Fe₂O₃ iron oxides, NaSO₄, vanadium oxides, zinc borate, silicates such as aluminium silicates and magnesium silicates, one-, two- and three-dimensional silicates, and talc. Mixtures and doped compounds are likewise usable. In addition, these ultrafinely divided inorganic compounds may have been surface-modified with organic molecules in order to achieve better compatibility with the polymers. In this way, it is possible to produce hydrophobic or hydrophilic surfaces. Particular preference is given to hydrated aluminium oxides (e.g. boehmite) or TiO₂.

Particle size and particle diameter of the inorganic particles mean the mean particle diameter d₅₀, determined, for example, by sedimentation measurements via the settling rate of the particles, for example in a Sedigraph.

The inorganic compounds may be in the form of powders, pastes, sols, dispersions or suspensions. By precipitation, it is possible to obtain powders from dispersions, sols or suspensions.

The inorganic compounds can be incorporated into the thermoplastic moulding compositions by customary processes, for example by direct kneading or extrusion of moulding compositions and the ultrafinely divided inorganic compounds. Preferred processes are the production of a masterbatch, for example in flame retardant additives and at least one component of the moulding compositions in monomers or solvents, or the co-precipitation of a thermoplastic component and the ultrafinely divided inorganic compounds, for example by co-precipitation of an aqueous emulsion and the ultrafinely divided inorganic compounds, optionally in the form of dispersions, suspensions, pastes or sols of the ultrafinely divided inorganic materials.

The compositions are produced by mixing the respective constituents in a known manner and compounding and extruding them in the melt at temperatures of 200° C. to 300° C., in standard apparatus such as internal kneaders, extruders and twin-shaft screw systems. The individual constituents can be mixed in a known manner, either successively or simultaneously, and either at about 20° C. (room temperature) or at a higher temperature.

The thermoplastic compositions and moulding compositions, because of their excellent balance of high impact resistance at low temperatures, good flame retardancy with low wall thicknesses and excellent chemical stability, are suitable for production of battery module housings or battery pack housings or parts thereof.

In one embodiment, component C is selected from phosphorus compounds of formula

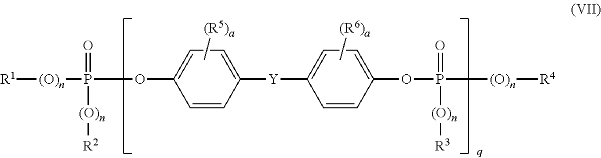

in which
R¹, R², R³ and R⁴ are each independently optionally halogen-substituted C₁- to C₈-alkyl, in each case optionally halogen- and/or alkyl-substituted C₅- to C₆-cycloalkyl, C₆- to C₁₀-aryl or C₇- to C₁₂-aralkyl,
n is independently 0 or 1,
a is independently 0. 1, 2, 3 or 4,
q is 0 to 30,
R⁵ and R⁶ are each independently C₁- to C₄-alkyl, preferably methyl, or halogen, preferably chlorine and/or bromine, and
Y is C₁- to C₇-alkylidene, C₁- to C₇-alkylene, C₅- to C₁₂-cycloalkylene, C₅- to C₁₂-cycloalkylidene, —O—, —S—, —SO—, —SO₂— or —CO—.

In a further embodiment, in which the polycarbonate composition contains components A+B+C and optionally components D, F and/or F, the proportion of component B is 9.0 to 11.0 parts by weight (based on the sum total of components A+B+C).

In a further embodiment, in which the polycarbonate composition contains components A+B*+C and optionally components D, E and/or F, the proportion of component B* is 9.0 to 11.0 parts by weight (based on the sum total of components A+B*+C).

In a further embodiment, the proportion of component C is 4.0 to 11.0 parts by weight (based on the sum total of components A+B+C or A+B*+C).

In a further embodiment, the polycarbonate composition contains, as component C, a mixture of a monophosphate and an oligophosphate of formula (VII), the average value of q being 1.06 to 1.15.

In a further embodiment, the proportion of component D is 0.1 to 0.6 part by weight (based on the sum total of components A+B+C or A+B*+C).

In a further embodiment, the polycarbonate composition contains, as component F, at least one additive selected from the group consisting of lubricants and demoulding agents, nucleating agents, antistats, stabilizers, dyes, pigments, fillers, reinforcers and ultrafinely divided inorganic compounds, where the ultrafinely divided inorganic compounds have an average particle diameter of less than or equal to 200 nm.

As well as or instead of polycarbonate materials, the battery module housing, especially the safety wall sections, may also comprise other suitable plastics, for example flame-retardant thermosets and thermoplastics. Examples thereof are: nylon-6 (PA6), nylon-6,6 (PA66), polybutylene terephthalate (PBT), PBT mixtures, polypropylene (PP), acrylonitrile-butadiene-styrene (ABS) or mixtures thereof, preferably in each case with addition of flame retardants.

In a further embodiment of the battery module, the safety wall section has exactly or essentially a thickness of 0.5 mm to 3 mm, preferably of 0.8 mm to 2 mm, especially of 1 mm to 2 mm. Experiments have shown that the necessary burn-through times are achievable particularly with such low wall thicknesses. Safety wall sections including polycarbonate materials preferably have, in particular, a thickness in the range from 0.8 mm to 2 mm.

If the material of the safety wall section and the rest of the battery module housing is the same, the rest of the battery module housing, i.e., the housing in regions other than in the region of the safety wall section, has a greater wall thickness than the safety wall section. Preferably, the wall thickness of the rest of the battery module housing in this case is 3 mm to 5 mm.

In a further embodiment of the battery module, the battery module housing has fins at least in the region of the safety wall section, preferably on the respective whole side of the battery module housing or essentially on the respective whole side of the battery module housing.

The provision of fins can achieve greater stability given the same wall thickness, or the same stability given a lower wall thickness, of the safety wall section. Preferably, the whole or essentially the whole respective side of the battery module housing may have fins, i.e. that side in which the safety wall section is disposed. In the case of a safety wall section in the underside of the battery module housing, for example, the entire underside of the battery module housing may have fins.

If a wall section has fins, this is understood to mean that the wall section has fin-shaped protrusions which increase the structural stability of the wall section. The protrusions may consist, for example, of the same material as the wall section and may preferably be configured in one piece together therewith. In the case of production of the battery module housing or parts thereof in an injection moulding operation, the protrusions may be included, for example, in the injection mould and thus be injection-moulded as well directly. The provision of fins may comprise a multitude of fins crossing one another, in which case the wall regions between the individual fins may be configured so as to be correspondingly thinner.

In a further embodiment of the battery module, the battery module housing, in the region of the safety wall section, has a hole covered with a film. For this purpose, for example, in the course of production of the battery module housing, a hole may be provided in the region of the safety wall section, and is subsequently closed with a film. The film may, for example, be bonded or welded to the material of the battery module housing that surrounds the hole, or be secured thereto in another way. In that case, the wall thickness in the safety wall section corresponds to the film thickness, which may, for example, be in the range from 10 μm to 500 μm. With this embodiment, it is thus possible to achieve particularly low wall thicknesses in the safety wall section. Useful films for the film are especially made of plastic, for example of one of the plastics described above for the battery module housing.

In a further embodiment of the battery module, the battery module comprises the given number of battery cells, the individual battery cells being disposed in the accommodation spaces. Given N accommodation spaces, the battery module accordingly comprises N battery cells, with one battery cell arranged in each accommodation space for a battery cell. The battery cells may especially be lithium ion accumulators, for example of the 18650 type, or alternatively of the 10180, 10280, 10440, 14250, 14500, 14560, 15270, 16340, 17340, 17500, 17670, 18350, 18500, 19670, 25500, 26650 or 32600 type or of the coffee-bag type.

In a further embodiment of the battery module, at least one of the battery cells has a preferential fracture site for the escape of a flame in a preferential direction, and the battery cell is disposed in an accommodation space such that the preferential direction is in line with the safety wall section of the accommodation space. The preferential fracture site of the battery cell may be disposed, for example, in the base region in the case of cylindrical battery cells, and in the edge region of the battery cell in the case of coffee-bag battery cells.

In this way, it is assured that any flame that escapes from the battery cell in the event of damage hits the safety wall section arranged in line, and so burns a hole in the battery module housing after a period of a few seconds, such that the energy from the flame can escape from the battery module.

In a further embodiment of the battery module, the underside of a battery cell is in line with the safety wall section of an accommodation space. Typically, battery cells have a preferential fracture site on the underside thereof. In the present embodiment, the battery module is matched to this position of the preferential fracture sites.

Particular preference is given in accordance with the invention to a battery module
having a battery module housing,
the battery module housing enclosing a battery module interior and
the battery module housing having, on the battery module interior side, accommodation
spaces for a given number of battery cells,
   wherein
the battery module housing comprises, in the region of at least one accommodation space, a safety wall section having such material properties and such a thickness that the safety wall section, in the needle flame test to DIN EN ISO 11925-2, burns through after not more than 45 s,
   wherein

the polycarbonate material comprised by the safety wall section of the battery module housing and by the other regions of the battery module housing is a polycarbonate composition containing the following components A+B+C or A+B*+C, and in each case optionally components D, E and/or F, with the proportions specified in each case:
A) 70.0 to 90.0 parts by weight (based on the sum total of the parts by weight of components A+B+C or A+B*+C) of linear and/or branched aromatic polycarbonate and/or aromatic polyester carbonate,
B) 6.0 to 15.0 parts by weight (based on the sum total of the parts by weight of components A+B*+C) of at least one graft polymer comprising
   B.1) 5% to 40% by weight (based in each case on the graft polymer B) of a shell composed of at least one vinyl monomer and
   B.2) 95% to 60% by weight (based in each case on the graft polymer B) of one or more graft bases composed of silicone-acrylate composite rubber,
B*) 6.0 to 15.0 parts by weight (based on the sum total of the parts by weight of components A+B*+C) of at least one graft polymer comprising
   B*.1) 5 to 95 parts by weight of a mixture of
      B*.1.1) 50 to 95 parts by weight of styrene, α-methylstyrene, styrene with methyl substitution on the ring, C₁- to C₈-alkyl methacrylate, C₁- to C₈-alkyl acrylate or mixtures of these compounds and
      B*.1.2) 5 to 50 parts by weight of acrylonitrile, methacrylonitrile, C₁- to C₈-alkyl methacrylates, C₁- to C₈-alkyl acrylate, maleic anhydride, N—C₁- to C₄-alkyl- or N-phenyl-substituted maleimides or mixtures of these compounds, grafted onto
   B*.2) 5 to 95 parts by weight of a rubber-containing butadiene- or acrylate-based graft base,
C) 2.0 to 15.0 parts by weight (based on the sum total of the parts by weight of components A+B+C or A+B*+C) of phosphorus compounds selected from the groups of mono- and oligomeric phosphoric and phosphonic esters, phosphonate amines, phosphazenes and phosphinates, and mixtures of these compounds,
D) 0 to 3.0 parts by weight (based on the sum total of the parts by weight of components A+B+C or A+B*+C) of anti-dripping agent,
E) 0-3.0 parts by weight (based on the sum total of the parts by weight of components A+B+C or A+B*+C) of thermoplastic vinyl (co)polymer (E.1) and/or polyalkylene terephthalate (E.2), and
F) 0 to 20.0 parts by weight (based on the sum total of the parts by weight of components A+B+C or A+B*+C) of further additives,
   wherein the compositions are preferably free of rubber-free polyalkyl(alkyl)acrylate, and wherein all the parts by weight stated in the present application are normalized such that the sum total of the parts by weight of components A+B+C or A+B*+C in the composition adds up to 100,

and wherein the wall thickness of the safety wall section is 0.8 mm to 2.0 mm, more preferably 0.8 mm to 1.0 mm,

and wherein the wall thickness in the region of the safety wall section is lower than in the other regions of the battery module housing, which preferably have a wall thickness of 3.0 mm to 5.0 mm, more preferably of 3.0 mm to 3.5 mm.

It will be appreciated that the battery cells disposed in the battery module housing may have very different sizes and shapes, for example cylindrical and small, similarly to AA cells, or else cylindrical and large, similarly to drinks cans. Therefore, according to the battery cell, there is significant variation in the flame energy that escapes in the event of failure. The thickness of the safety wall section and of the rest of the housing are preferably matched to the battery cell size. The situation is similar for prismatic cells and pouch cells.

The abovementioned object is also achieved in accordance with the invention, in a battery pack having a battery pack housing, the battery pack housing enclosing a battery pack interior and the battery pack housing having, on the battery pack interior side, at least one accommodation space for a battery module, at least partly by virtue of the battery pack having an inventive battery module accommodated in the accommodation space.

In electrical vehicles, it is generally the case that no individual battery modules are installed, but rather battery packs in which several battery modules are combined in one battery pack housing. By virtue of such a battery pack being equipped with inventive battery modules, the advantages described above for the inventive battery module are achieved.

To accommodate the battery modules, the battery pack may have, on the battery pack interior side, i.e. on the inside of the battery pack housing, for example, supports, rails, recesses or other holding means.

In one embodiment of the battery pack, the battery pack has, in the battery pack interior, on the side of the safety wall section of the battery module housing, a clearance region, such that the battery module is spaced apart in this region from the battery pack housing and other battery modules in the battery pack.

The spacing-apart of the battery pack in the region of the safety wall section provides a safety clearance into which the energy from any flame that can escape in the event of damage from a battery cell disposed in the battery module and can bum through the battery module housing in the region of a safety wall section arranged in line can be introduced. In this way, it is possible to prevent the energy from the flame from damaging other components within the battery pack or the battery pack itself. For this purpose, the distance between the battery module and the battery pack housing and other battery modules on the side of the safety wall section of the battery module is preferably at least 5 cm.

In a further embodiment of the battery pack, the battery pack has, in the battery pack interior, on the side of the safety wall section of the battery module housing, a channel designed to lead off the energy from a flame that escapes through the safety wall section. In a further embodiment of the battery pack, the battery pack housing has a safety wall section which is in line with the safety wall section of the battery module housing and which has such material properties and such a thickness that the safety wall section, in the needle flame test to DIN EN ISO 11925-2, burns through after not more than 45 s, preferably not more than 20 s, further preferably not more than 10 s, especially not more than 5 s.

If the material of the safety wall section and the rest of the battery pack housing is the same, the rest of the battery pack housing, i.e. the housing in regions other than in the region of the safety wall section, has a greater wall thickness than the safety wall section. Preferably, the wall thickness of the safety section is 0.8 mm to 2.0 mm, further preferably 0.8 to 1.0 mm, and the wall thickness of the rest of the battery pack housing is 3.0 mm to 5.0 mm, further preferably 3.0 to 3.5 mm, in this case.

Preferably, the material properties and the thickness of the safety wall section are such that the safety wall section, on contact with a flame having a temperature of at least 600° C., has burnt through after not more than 5 s, preferably not more than 4 s and especially not more than 3 s, such that a hole forms in this region in the battery pack housing.

Any flame that escapes from a battery cell disposed in the battery module can thus, after burning through the safety wall section of the battery module, also burn through the safety wall section of the battery pack. In this way, the energy from the flame can be led off not just from the battery module housing but also from the surrounding battery pack housing.

In a further embodiment of the battery pack, at least the safety wall section of the battery pack housing, preferably the entire or essentially the entire battery pack housing, comprises a flame-retardant material, especially a flame-retardant plastic. As detailed above in relation to the safety wall section of the battery module housing and to the battery module housing itself, the use of such a material can prevent the safety wall section, or the battery module or battery pack housing, from continuing to burn after the extinguishment of any flame that escapes from a battery cell. This can prevent the spread of a fire.

In a further embodiment of the battery pack, at least the safety wall section of the battery pack housing, preferably the entire or essentially the entire battery pack housing, comprises a polycarbonate material. As detailed above in relation to the safety wall section of the battery module housing and to the battery module housing itself, polycarbonate materials have good elasticity and high toughness, especially even at low temperatures of −30° C., as can occur in the case of use in electrical vehicles. In addition, good flame retardancy of these materials is possible.

Useful polycarbonate materials for the safety wall section of the battery pack housing, especially for the battery pack housing itself, are in principle the polycarbonate compositions already detailed above for the safety wall section of the battery module housing and for the battery module housing itself, and so reference is made to the description in that regard.

In addition, the other materials mentioned above for the safety wall section of the battery module housing and for battery module housing itself are also useful for the safety wall section of the battery pack housing and for the battery pack housing itself, especially the flame-retardant thermoplastics.

In a further embodiment of the battery pack, the battery pack housing, in the region of the safety wall section, has a hole covered with a film. For this purpose, for example, in the course of production of the battery pack housing, a hole may be provided in the region of the safety wall section, and is subsequently closed with a film. The film may, for example, be bonded or welded to the material of the battery pack housing that surrounds the hole, or be secured thereto in another way. In that case, the wall thickness in the safety wall section corresponds to the film thickness, which may, for example, be in the range from 10 μm to 500 μm. With this embodiment, it is thus possible to achieve particularly low wall thicknesses in the safety wall section. Useful films for the film are especially made of plastic, for example of one of the plastics described above for the battery module housing.

The abovementioned object is additionally achieved in accordance with the invention, in an electrical vehicle, at least partly by virtue of the electrical vehicle having an inventive battery module and/or an inventive battery pack.

The provision of such a battery module or battery pack in an electrical vehicle, because of the increased operational reliability of the battery module or battery pack, can correspondingly also improve the operational reliability of the electrical vehicle. With regard to the other advantages, reference is made to the above description with regard to the battery module and the battery pack.

In one embodiment of the electrical vehicle, the battery module or the battery pack is arranged in the electrical vehicle such that a safety wall section of the battery module or of the battery pack is spaced apart from other component surfaces of the electrical vehicle, especially from bodywork surfaces.

The spacing-apart of the safety wall section from component surfaces of the electrical vehicle provides a safety clearance into which the energy from any flame that escapes from the battery module or from the battery pack can be led off, such that the risk of damage to components, especially to bodywork components and in particular combustible plastic components of the electrical vehicle is reduced. In addition, the safety clearance achieves the effect that the energy from the flame is not returned to the battery module or to the battery pack through the components of the electrical vehicle, especially through the bodywork components thereof. This can further increase the operational reliability of the electrical vehicle.

The distance between the safety wall section of the battery module or of the battery pack from other component surfaces of the electrical vehicle, especially from bodywork surfaces, is preferably at least 5 cm. This provides a sufficiently large safety clearance to be able to reliably lead off the energy from any flame that escapes from the battery pack or battery module. Preferably, the distance can be achieved by provision of a spacer disposed between the battery module or the battery pack and another component surface of the electrical vehicle. For example, a support may be provided, with which the battery module or the battery pack is supported on a bodywork surface of the electrical vehicle.

Further features and advantages of the present invention can be inferred from the description of working examples which follows, reference being made to the appended drawing.

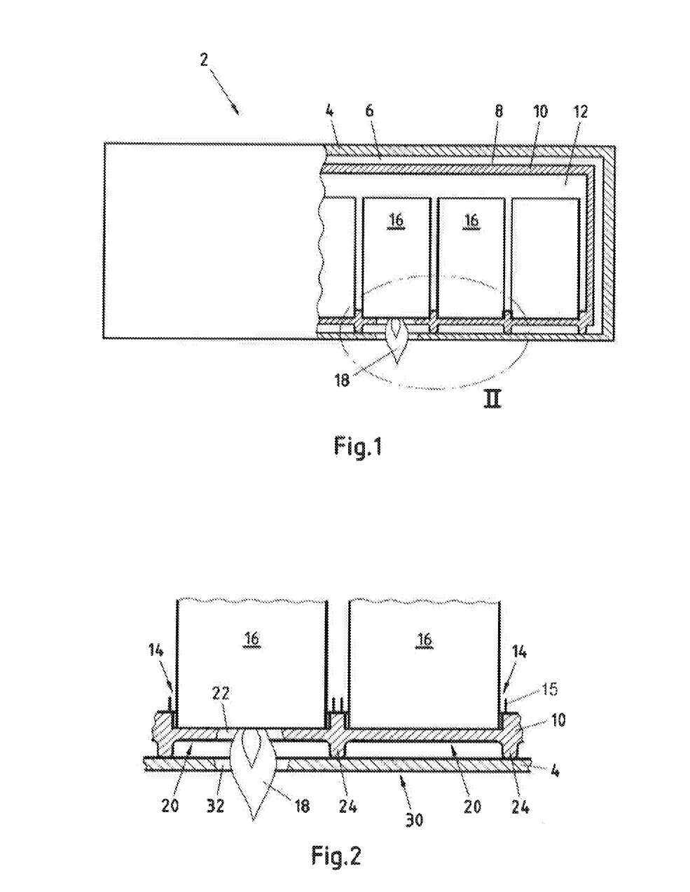

FIG. 1 shows a working example of an inventive battery module and of an inventive battery pack,

FIG. 2 shows a detail from the working example from FIG. 1,

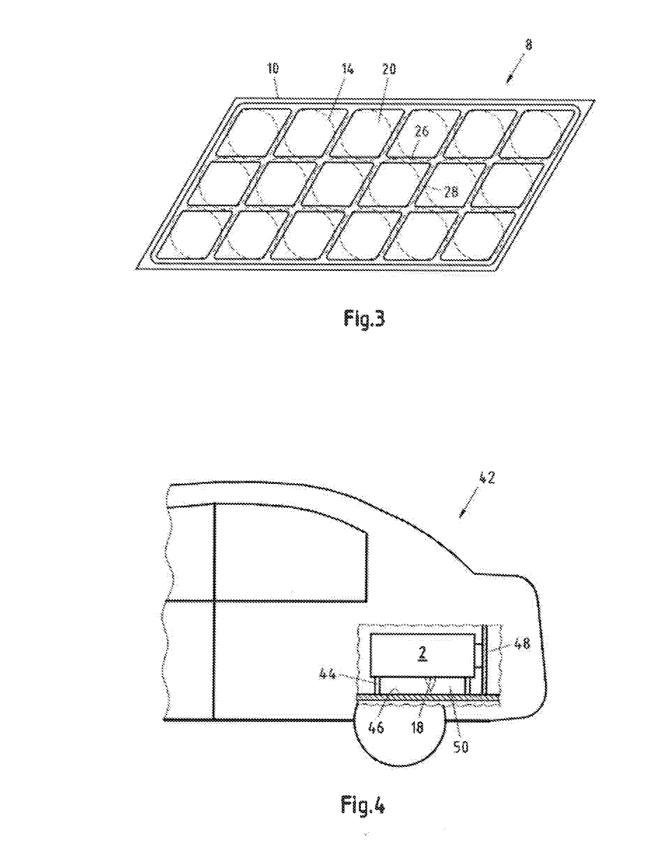

FIG. 3 shows the battery module from FIG. 1 in a view from beneath and

FIG. 4 shows a working example of an inventive electrical vehicle with an inventive battery pack.

FIG. 1 shows a working example of an inventive battery pack 2 and of an inventive battery module 8 in cross section. FIG. 2 additionally shows the section marked with II in FIG. 1 in an enlarged and more detailed illustration.

The battery pack 2 has a battery pack housing 4 which encloses a battery pack interior 6. On the battery pack interior side, the battery pack housing 4 has a plurality of accommodation spaces (not shown) for battery modules.

Disposed in the accommodation spaces are battery modules, of which the battery module 8 is visible in FIG. 1. The battery module 8 has a battery module housing 10 which encloses a battery module interior 12. On the battery module interior side, the battery module housing 10 has accommodation spaces 14 for a given number of battery cells 16. The accommodation spaces 14 may, for example, as shown in FIG. 2, be introduced into the battery module housing 10 in the form of essentially circular recesses. Alternatively or additionally, the accommodation spaces 14 may also have collars 15 arranged on the inside of the battery module housing, which form an essentially circular edge, for example, to accommodate a battery cell 16.

The battery module 8 has, in FIG. 1, the given number of battery cells 16, with one battery cell 16 arranged in each accommodation space 14 of the battery module 8. The battery cells 16 are, for example, lithium ion accumulators in cylinder shape. The battery cells 16 each have, at the base, a preferential fracture site (not shown), such that any flame 18 that escapes from a battery cell 16 in the event of damage does not escape at an arbitrary point in the battery cell 16, but escapes specifically at the underside thereof.

The battery module housing 10 has, in the region of each accommodation space 14, a safety wall section 20 having such material properties and such a thickness that the safety wall section 20, in the needle flame test to DIN EN ISO 11925-2, burns through after not more than 45 s, better not more than 20 s, preferably not more than 10 s, especially not more than 5 s. This achieves the effect that the safety wall section 20, on contact with a flame 18 which may have, for example, a temperature of about 600° C., has burnt through after a few seconds, especially after not more than 5 seconds, such that a hole 22 forms in this region in the battery module housing.

The safety wall section 20 may comprise, for example, a flame-retardant polycarbonate material. The thickness of the safety wall section 20 in this region is preferably 0.8 to 2 mm. In this way, burn-through of the safety wall section 20 on contact with the flame 18 is achieved within the given time. The use of a flame-retardant polycarbonate material additionally has the advantage that the polycarbonate material does not continue to burn after the flame 18 has been extinguished, but is likewise extinguished, and so the fire cannot spread.

The battery module housing side in which the safety wall sections 20 are disposed has fins 24 in the form of a plurality of crossing protrusions. By virtue of these fins 24, the wall thickness of the safety wall sections 20 may be very thin, without too much deterioration in the structural properties of the battery module housing 10.

FIG. 3 shows a view of the battery module 8 from beneath, with one possible configuration of the fins 24. The battery module 8 has, on the battery module interior side, in this example, five by three accommodation spaces 14 for a total of 15 battery cells, for example of the 18650 type. The accommodation spaces 14 are each arranged in an offset manner in rows, in order to achieve a maximum packing density and hence space saving. This gives rise to an overall rhombus-shaped cross section for the battery module housing 10.

The underside of the battery module housing 10 has a number of essentially longitudinal fins 26 and a number of essentially transverse fins 28, which give rise overall to a fin pattern 24 of the battery module housing 10 adapted to the arrangement of the accommodation spaces 14, this having a rhombus shape in the present example. Preferably, the fins 24 are arranged such that the fins each run outside the safety wall sections 20. In this way, it is assured that a safety wall section, on contact with a flame 18, burns through it within the given time, without hindrance of the burn-through by the fins 26, 28.

The battery pack housing 4 of the battery pack 2 has safety wall sections 30 which are in line with the safety wall sections 20 and have such material properties and such a thickness that the safety wall sections 30, in the needle flame test to DIN EN ISO 11925-2, burn through after not more than 45 s, better not more than 20 s, preferably not more than 10 s, especially not more than 5 s. This achieves the effect that the safety wall sections 30, on contact with a flame 18, have burnt through after a few seconds, such that a hole 32 forms in this region in the battery pack housing 4. Thus, any flame 18 that escapes from a battery cell 16 can burn first through the battery module housing 10 in the safety wall section 20 and then through the battery pack housing 4 in the safety wall section 30. As a result, the energy from the flame can get out of both the battery module 8 and the battery pack 2, such that damage to further battery cells 16 can be prevented.

For provision of the safety wall sections 30 in the battery pack housing 4, the underside of the battery pack housing 4 has a reduced thickness of 0.8 mm throughout. The safety wall sections 30 thus form a combined, large safety wall section. Preferably, the underside of the battery pack housing 4, especially essentially the entire battery pack housing 4, comprises a flame-retardant polycarbonate material.

FIG. 4 shows a working example of an inventive electrical vehicle in a schematic partial view from the side. In the lower part of the luggage compartment space of the electrical vehicle 42 is disposed the battery pack 2 from FIG. 1. The battery pack 2 is secured by means of supports 44 on a component surface 46 of the electrical vehicle 42. For a secure fit, the battery pack 2 is additionally secured laterally on an essentially vertical component structure 48 of the electrical vehicle 42.

The supports 44 provide a safety clearance 50 between the underside of the battery pack 2 and the component surface 46, such that, in the event of damage, any flame 18 that escapes from the battery pack 2 does not directly hit the component surface 46, but is conducted into the safety clearance 50.

This can reduce or prevent any damage to the component surface 46 by the flame 18. In addition, energy from the flame 18 is prevented from being returned through the component surface 46 to the battery pack 2, where there could otherwise be damage to further battery cells 16 through the energy from the flame 18.

Further examples of polycarbonate compositions are described hereinafter, these being particularly suitable for safety wall sections of battery module housings or battery pack housings, or for battery module housings or battery pack housings or parts thereof.

### EXAMPLES

Component A-1

Linear polycarbonate based on bisphenol A having a relative solution viscosity of ηᵣₑₗ=1.28, measured in CH₂Cl₂ as solvent at 25° C. and a concentration of 0.5 g/100 ml.

Component B-1:

Silicone-acrylate composite rubber having the following composition:

polymethylmethacrylate/silicone rubber/acrylate rubber: 14%/31%/55% by weight

Component B-2:

Silicone-acrylate composite rubber having the following composition:

polymethylmethacrylate/silicone rubber/acrylate rubber: 11%/82%/7% by weight

Component B*:

ABS polymer prepared by emulsion polymerization of 43% by weight (based on the ABS polymer) of a mixture of 27% by weight of acrylonitrile and 73% by weight of styrene in the presence of 57% by weight (based on the ABS polymer) of a particulate crosslinked polybutadiene rubber (median particle diameter d₅₀=0.35 μm), the graft polymer containing about 15% free, soluble SAN. The gel content is 72%.

Component C:

Bisphenol A-based oligophosphate (Reofoss BAPP) of formula (VIa)

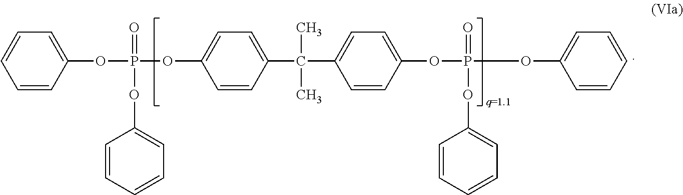

Component D:

Polytetrafluoroethylene powder, CFP 6000 N, from DuPont.

Component F:

F-1: Pentaerythrityl tetrastearate as lubricant/demoulding agent

F-2: Phosphite stabilizer, Irganox® B900 (mixture of 80% Irgafos® 168 and 20% Irganox® 1076; BASF AG; Ludwigshafen/Irgafos® 168 (tris(2,4-di-tert-butyl-phenyl)phosphite)/Irganox® 1076 (2,6-di-tert-butyl-4-(octadecanoxycarbonylethyl)phenol).

In a twin-screw extruder (Werner and Pfleiderer ZSK-25), the feedstocks listed in Table 1 are compounded and pelletized at a speed of 225 rpm and a throughput of 20 kg/h at a machine temperature of 260° C. The finished pellets are processed in an injection-moulding machine to give appropriate specimens (melt temperature 240° C., mould temperature 80° C., flow front speed 240 mm/s).

In the same way, in a twin-screw extruder (Werner and Pfleiderer ZSK-25), the feedstocks listed in Table 2 are compounded and pelletized at a speed of 225 rpm and a throughput of 20 kg/h at a machine temperature of 260° C. The finished pellets are processed in an injection-moulding machine to give appropriate specimens (melt temperature 240° C., mould temperature 80° C., flow front speed 240 mm/s).

The properties of the specimens are characterized by employing the following methods:

Flowability was determined to ISO 11443 (melt viscosity).

Notched impact resistance ak was measured to ISO 180/1A on a test specimen which had been injection-moulded from one side and had dimensions of 80×10×4 mm, at the test temperatures specified.

Heat distortion resistance was measured to DIN ISO 306 (Vicat softening temperature, method B with load 50 N and a heating rate of 120 K/h) on a test specimen which had been injection-moulded from one side and had dimensions of 80×10×4 mm.

Flammability characteristics are measured to UL 94V on bars of dimensions 127×12.7×1.5 mm.

Elongation at break and tensile modulus of elasticity were measured to DIN EN ISO 527 on bars of dimensions 170.0×10.0×4.0 mm.

Chemical resistance (ESC characteristics) is understood to mean the time before fracture at 2.4% edge fibre elongation after storage of the specimen in the given test substances at room temperature, in a test specimen which has been injection-moulded from one side and has dimensions of 80×10×4 mm.

TABLE 1
Compositions and properties thereof

| | | 1 | 2 | 3 | 4 |
|---|---|---|---|---|---|
| Components | % by wt. | | | | |
| A1 | | 84.10 | 78.10 | 84.10 | 78.10 |
| B1 | | | | 9.00 | 11.00 |
| B2 | | 9.00 | 11.00 | | |
| C | | 6.00 | 10.00 | 6.00 | 10.00 |
| d | | 0.40 | 0.40 | 0.40 | 0.40 |
| F1 | | 0.40 | 0.40 | 0.40 | 0.40 |
| F2 | | 0.10 | 0.10 | 0.10 | 0.10 |
| Sum total | | 100.00 | 100.00 | 100.00 | 100.00 |
| Properties | Units | | | | |
| ak ISO 180/1A at RT | [kJ/m²] | 59 | 57 | 60 | 58 |
| ak ISO 180/1A at −20° C. | [kJ/m²] | 45 | 42 | 42 | 37 |
| ak ISO 180/1A at −40° C. | [kJ/m²] | 32 | 30 | 20 | 18 |
| Vicat B 120 | [° C.] | 120 | 109 | 120 | 109 |
| UL 94 V/1.5 mm | | V-0 | V-0 | V-0 | V-0 |
| Afterflame time | [s] | 10 | 12 | 20 | 16 |
| Melt viscosity 260° C./1000 s⁻¹ | [Pas] | 370 | 297 | 366 | 292 |
| ESC with 2.4% toluene/isopropanol | h:min | 14:08 | 30:00 | 7:00 | 1436 |
| (60:40) | | | | | |
| ESC with 2.4% rapeseed oil | h:min | 7:45 | 2:45 | 7:00 | 2:39 |
| ESC with 2.4% glycol/water (50:50) | h:min | 125:50 | 124:00 | 122:20 | 67:00 |
| ESC with 2.4% hydraulic oil | h:min | 168:00 | 168:00 | 16800 | 168:00 |
| Tensile modulus of elasticity | N/mm² | 2248 | 2258 | 2242 | 2263 |
| Elongation at break | % | 106 | 110 | 103 | 110 |

TABLE 2
Compositions and properties thereof

| | | 5 | 6 |
|---|---|---|---|
| Components | % by wt. | | |
| A1 | | 84.10 | 78.10 |
| B* | | 9.00 | 11.00 |
| C | | 6.00 | 10.00 |
| D | | 0.40 | 0.40 |
| F-1 | | 0.40 | 0.40 |
| F-2 | | 0.10 | 0.10 |
| Sum total | | 100.00 | 100.00 |
| Properties | Units | | |
| ak ISO 180/1A at RT | [kJ/m²] | 52 | 57 |
| ak ISO 180/1A at −20° C. | [kJ/m²] | 34 | 33 |
| ak ISO 180/1A at −40° C. | [kJ/m²] | 18 | 17 |
| at weld seam | [kJ/m²] | 74 | 73 |
| Table B 120: | ° C. | 120 | 110 |
| UL 94 V/1.5 mm | | V-1 | V-1 |
| Afterflame time | s | 54 | 50 |
| UL 94 V/2.5 mm | | V-0 | V-0 |
| Afterflame time | s | 15 | 11 |
| Melt viscosity | | | |
| 260° C./1000 s⁻¹ | [Pas] | 415 | 319 |
| ESC with 2.4% toluene/isopropanol | h:min | 2:42 | 4:01 |
| (60:40) | | | |
| ESC with 2.4% rapeseed oil | min | 357 | 205 |
| ESC with 2.4% glycol/water (50:50) | min | 108:00 | 149:00 |
| ESC with 2.4% hydraulic oil | min | 168:00 | 168:00 |
| Elongation at break | % | | |
| Tensile modulus of elasticity | N/mm² | 2340 | 2350 |

Toluene/isopropanol mixture: 60%/40% by weight

Experiments have shown that the aforementioned polycarbonate compositions can be used to produce safety wall sections of battery module housings, especially having a wall thickness in the range of 0.8 mm to 3 mm, which burn through in the needle flame test to DIN EN ISO 11925-2 after not more than 45 s, not more than 20 s, not more than 10 s or even not more than 5 s.

1.-16. (canceled)

17. Battery module comprising
a battery module housing,
the battery module housing enclosing a battery module interior and
the battery module housing comprising, on the battery module interior side, accommodation spaces for a given number of battery cells,
wherein
the battery module housing comprises, in the region of at least one accommodation space, a safety wall section comprising material properties and a thickness that the safety wall section, in the needle flame test to DIN EN ISO 11925-2, burns through after not more than 45 s.

18. The battery module according to claim 17, wherein the safety wall section is disposed in a region of the accommodation space formed for accommodation of the underside of a battery cell.

19. Battery module according to claim 17, wherein at least the safety wall section, comprises a polycarbonate material.

20. The battery module according to claim 19, wherein the polycarbonate material comprised by the safety wall section of the battery module housing is a polycarbonate composition containing the following components A+B+C or A+B*+C, and in each case optionally components D, E and/or F, with the proportions specified in each case:
A) 70.0 to 90.0 parts by weight (based on the sum total of the parts by weight of components A+B+C or A+B*+C) of linear and/or branched aromatic polycarbonate and/or aromatic polyester carbonate,
B) 6.0 to 15.0 parts by weight (based on the sum total of the parts by weight of components A+B+C) of at least one graft polymer comprising
B.1) 5% to 40% by weight (based in each case on the graft polymer B) of a shell composed of at least one vinyl monomer and
B.2) 95% to 60% by weight (based in each case on the graft polymer B) of one or more graft bases composed of silicone-acrylate composite rubber,
B*) 6.0 to 15.0 parts by weight (based on the sum total of the parts by weight of components A+B*+C) of at least one graft polymer comprising
B*.1) 5 to 95 parts by weight of a mixture of
B*.1.1) 50 to 95 parts by weight of styrene, α-methylstyrene, styrene with methyl substitution on the ring, C₁- to C₈-alkyl methacrylate, C₁- to C₈-alkyl acrylate or mixtures of these compounds and
B*.1.2) 5 to 50 parts by weight of acrylonitrile, methacrylonitrile, C₁- to C₈-alkyl methacrylates, C₁- to C₈-alkyl acrylate, maleic anhydride, N—C₁- to C₄-alkyl- or N-phenyl-substituted maleimides or mixtures of these compounds, grafted onto
B*.2) 5 to 95 parts by weight of a rubber-containing butadiene- or acrylate-based graft base,
C) 2.0 to 15.0 parts by weight (based on the sum total of the parts by weight of components A+B+C or A+B*+C) of phosphorus compounds selected from the groups of mono- and oligomeric phosphoric and phosphoric esters, phosphonate amines, phosphazenes and phosphinates, and mixtures of these compounds,
D) 0 to 3.0 parts by weight (based on the sum total of the parts by weight of components A+B+C or A+B*+C) of anti-dripping agent,
E) 0-3.0 parts by weight (based on the sum total of the parts by weight of components A+B+C or A+B*+C) of thermoplastic vinyl (co)polymer (E.1) and/or polyalkylene terephthalate (E.2), and
F) 0 to 20.0 parts by weight (based on the sum total of the parts by weight of components A+B+C or A+B*+C) of further additives,
wherein all the parts by weight stated in the present application are normalized such that the sum total of the parts by weight of components A+B+C or A+B*+C in the composition adds up to 100.

21. The battery module according to claim 17, wherein the safety wall section has a thickness in the range from 0.5 mm to 3 mm.

22. The battery module according to claim 17, wherein the battery module housing has fins at least in the region of the safety wall section.

23. The battery module according to claim 17, wherein the battery module has a given number of battery cells, the individual battery cells being disposed in the accommodation spaces, at least one of the battery cells having a preferential fracture site for the escape of a flame in a preferential direction, and the battery cell being disposed in an accommodation space such that the preferential direction is in line with the safety wall section of the accommodation space.

24. The battery module according to claim 17, wherein the battery module housing and the safety wall section fulfil at least the V-2 classification according to UL-94.

25. The battery module according to claim 17, wherein, if the material of the safety wall section and the material in regions of the battery module housing other than in the region of the safety wall section is the same, the wall thickness in the region of the safety wall section is lower than in the other regions of the battery module housing.

26. The battery module according to claim 17, wherein the material properties and the thickness of the safety wall section are such that the safety wall section, in the needle flame test to DIN EN ISO 11925-2, burns through after not more than 20 s, further preferably not more than 10 s, especially not more than 5 s.

27. A battery pack
having a battery pack housing,
the battery pack housing enclosing a battery pack interior and
the battery pack housing having, on the battery pack interior side, at least one accommodation space for a battery module, wherein
the battery pack has a battery module according to claim 17 accommodated in the accommodation space.

28. The battery pack according to claim 27, wherein the battery pack has, in the battery pack interior, on the side of the safety wall section of the battery module housing, a clearance region, such that the battery module is spaced apart in this region from the battery pack housing and other battery modules in the battery pack.

29. The battery pack according to claim 27, wherein the battery pack housing has a safety wall section which is in line with the safety wall section of the battery module housing and has such material properties and such a thickness that the safety wall section, in the needle flame test to DIN EN ISO 11925-2, burns through after not more than 45 s.

30. The battery pack according to claim 29, wherein at least the safety wall section of the battery pack housing comprises a polycarbonate material, the polycarbonate material comprised by the safety wall section of the battery pack housing being a polycarbonate composition containing the following components A+B+C or A+B*+C, and in each case optionally components D, E and/or F, with the proportions specified in each case:
A) 70.0 to 90.0 parts by weight (based on the sum total of the parts by weight of components A+B+C or A+B*+C) of linear and/or branched aromatic polycarbonate and/or aromatic polyester carbonate,
B) 6.0 to 15.0 parts by weight (based on the sum total of the parts by weight of components A+B+C) of at least one graft polymer comprising
B.1) 5% to 40% by weight (based in each case on the graft polymer B) of a shell composed of at least one vinyl monomer and
B.2) 95% to 60% by weight (based in each case on the graft polymer B) of one or more graft bases composed of silicone-acrylate composite rubber,
B*) 6.0 to 15.0 parts by weight (based on the sum total of the parts by weight of components A+B*+C) of at least one graft polymer comprising
B*.1) 5 to 95 parts by weight of a mixture of
B*.1.1) 50 to 95 parts by weight of styrene, α-methylstyrene, styrene with methyl substitution on the ring, C₁- to C₈-alkyl methacrylate, C₁- to C₈-alkyl acrylate or mixtures of these compounds and
B*.1.2) 5 to 50 parts by weight of acrylonitrile, methacrylonitrile, C₁- to C₈-alkyl methacrylates, C₁- to C₈-alkyl acrylate, maleic anhydride, N—C₁- to C₄-alkyl- or N-phenyl-substituted maleimides or mixtures of these compounds, grafted onto
B*.2) 5 to 95 parts by weight of a rubber-containing butadiene- or acrylate-based graft base,
C) 2.0 to 15.0 parts by weight (based on the sum total of the parts by weight of components A+B+C or A+B*+C) of phosphorus compounds selected from the groups of mono- and oligomeric phosphoric and phosphonic esters, phosphonate amines, phosphazenes and phosphinates, and mixtures of these compounds,
D) 0 to 3.0 parts by weight (based on the sum total of the parts by weight of components A+B+C or A+B*+C) of anti-dripping agent,
E) 0-3.0 parts by weight (based on the sum total of the parts by weight of components A+B+C or A+B*+C) of thermoplastic vinyl (co)polymer (E.1) and/or polyalkylene terephthalate (E.2), and
F) 0 to 20.0 parts by weight (based on the sum total of the parts by weight of components A+B+C or A+B*+C) of further additives,
wherein all the parts by weight stated in the present application are normalized such that the sum total of the parts by weight of components A+B+C or A+B*+C in the composition adds up to 100.

31. The battery pack according to claim 27, wherein, if the material of the safety wall section of the battery pack and the material in regions of the battery pack housing other than in the region of the safety wall section is the same, the wall thickness in the region of the safety wall section is lower than in the other regions of the battery pack housing.

32. An Electrical vehicle, wherein the electrical vehicle comprises a battery module according to claim 17.

33. An Electrical vehicle, wherein the electrical vehicle comprises a battery pack according to claim 27.
